(19) United States
(12) Patent Application Publication
(10) Pub. No.: US 2025/0358551 A1
(43) Pub. Date: Nov. 20, 2025

(54) SILICON-BASED OPTOELECTRONIC TRANSCEIVER INTEGRATED CHIP FOR PON OLT SYSTEM

(71) Applicants: SONT TECHNOLOGIES (SHEN ZHEN) LTD, Shenzhen (CN); SONT TECHNOLOGIES (NAN CHANG) LTD, Nanchang (CN)

(72) Inventors: Zhijian WEI, Shenzhen (CN); Guowei XU, Shenzhen (CN); BO ZHENG, Shenzhen (CN); Kaijia GUO, Shenzhen (CN)

(21) Appl. No.: 18/867,021

(22) PCT Filed: Nov. 30, 2022
(86) PCT No.: PCT/CN2022/135717

§ 371 Date: Nov. 19, 2024

(30) Foreign Application Priority Data
May 19, 2022 (CN) 202210541553.2

(51) Int. Cl. H04Q 11/00

(52) U.S. Cl. CPC H04Q 11/0067; H04Q 11/0003

(57) ABSTRACT

The embodiment of the present disclosure relates to a silicon-based optoelectronic transceiver integrated chip for a PON OLT system, an optical engine for a PON OLT system, a central office module, and a PON OLT system board. The transceiver integrated chip is located in the optical engine of an OLT and is configured to modulate an optical signal based on single path/two paths/or four paths of driving electrical signals, and the modulated downlink optical signal is subjected to gain processing of the optical engine and then is transmitted via an optical interface of the optical engine. The transceiver integrated chip is configured to perform photoelectric conversion on an uplink optical signal received by the optical interface of the optical engine and then to transmit the photoelectrically converted uplink optical signal to a burst mode receiving and amplifying chipset of the OLT located on an external region of the optical engine for processing. The central office module is module employing SFP-DD/SFP-DD112 package. The central office module can be configured flexibly in terms of rate, and is compatible with different standards and application scenarios, and can effectively reduce costs.

### TECHNICAL FIELD

The present disclosure relates to the technical field of optical communications, and in particular to a silicon-based optoelectronic transceiver integrated chip for a PON (Passive Optical Network) OLT (Optical Line Terminal) system.

### BACKGROUND

Office equipment used in a passive optical network of more than 50 G is disclosed in the prior art, which includes gold fingers plugged into a system board, a continuous downlink transmitting channel of more than 50G, a burst uplink receiving channel of more than 25G and a Bi-directional BOSA (Bi-directional optical sub-component). The transmitting channel includes a DSP (Digital Signal Processor/Digital Signal Processing chip), a PAM4 (Pulsed Amplitude Modulation Four-level) driving unit, and a core-packaged optical subcomponent BOX. The DSP is configured to receive two paths of NRZ (Non Return to Zero) Tx (Transmitting) signals of 25 G of a system board, and combine the two path of signals into one path of PAM4 modulation signal of 50G. The PAM4 driving unit is configured to receive the PAM4 modulation signal to drive an external modulator in the core-packaged optical subcomponent to generate a transmitting PAM4 optical signal of 50G. The receiving channel includes a coaxially packaged TO (Transistor Outline), an LA (Linear Amplifier), and a CDR (Clock Data Recovery). The coaxially packaged TO is configured to receive optical signals and convert the optical signals into electrical signals, and the electrical signals, after being subjected to current-limiting and shaping by the LA and CDR, are input to the system board through gold fingers. Therefore, the central office equipment can increase the downlink rate of the access network from 10G to 50G and the uplink speed to 25G.

In the research process, the inventor found that the existing optical channel transmission and reception are achieved by coaxially packaged TO and core-packaged optical subcomponent, such as BOSA optical subcomponent, which occupy space, have high cost, and cannot meet the requirements of miniaturization and multi-rate of central office equipment.

### SUMMARY

In view of the shortcomings and defects in the prior art, the embodiment provides a silicon-based optoelectronic transceiver integrated chip and optical engine for a PON OLT system, a central office module, and a PON OLT system board.

A multi-rate central office module based on the silicon-based optoelectronic integrated chip provided by the embodiment can effectively reduce the occupied volume and can adapt to multi-rate scenarios.

In a first aspect, it is provided a silicon-based optoelectronic transceiver integrated chip for a PON OLT system according to an embodiment of the present disclosure. The transceiver integrated chip is located in the optical engine of an OLT and is an integrated chip for achieving the integration of transmitting and receiving, and the transceiver integrated chip is configured to modulate an optical signal based on single path/two paths/or four paths of driving electrical signals generated by a modulation driving component of the OLT, and the modulated downlink optical signal is subjected to gain processing of the optical engine and then is transmitted via an optical interface of the optical engine.

The transceiver integrated chip is configured to perform photoelectric conversion on an uplink optical signal received by the optical interface of the optical engine and then to transmit the photoelectrically converted uplink optical signal to a burst mode receiving and amplifying chipset of the OLT located on an external region of the optical engine for processing.

In a possible implementation, in a case that the driving electrical signal is one path of driving electrical signal, the modulated downlink optical signal is one path of downlink optical signal.

In a case that the driving electrical signals are two paths of independent driving electrical signals, the transceiver integrated chip is configured to modulate an optical signal based on each path of driving electrical signal, and the modulated downlink optical signals are two paths of downlink optical signals.

In a case that the driving electrical signals are four paths of independent driving electrical signals, the transceiver integrated chip is configured to modulate an optical signal based on each path of driving electrical signal, and the modulated downlink optical signals are four paths of downlink optical signals.

In a case that the uplink optical signal received by the optical interface is one path of uplink optical signal, the transceiver integrated chip is configured to perform photoelectric conversion on the path of uplink optical signal and to output one path of converted electrical signal.

In a case that the uplink optical signals received by the optical interface are two paths of uplink optical signals, the transceiver integrated chip is configured to perform photoelectric conversion on the two paths of uplink optical signals and to output two paths of converted independent electrical signals.

In a case that the uplink optical signals received by the optical interface are four paths of uplink optical signals, the transceiver integrated chip is configured to perform photoelectric conversion on the four paths of uplink optical signals and to output four paths of converted independent electrical signals.

In a possible implementation, when the driving electrical signal is one path of driving electrical signal, i.e., a second parameter, the transceiver integrated chip includes:
a silicon photonic coupler, a silicon photonic modulator, a silicon photonic multiplexer/demultiplexer, and a silicon photonic PIN (Positive Intrisnic Negative) receiver.

The silicon photonic coupler is configured to receive a laser signal which is transmitted from a laser component in the optical engine and serves as a downlink light source, the downlink light source is transmitted via an optical path into the silicon photonic modulator for modulation, and the silicon photonic modulator is configured to modulate the downlink light source based on the driving electrical signal, so as to obtain a modulated optical signal.

The modulated optical signal is transmitted to the silicon photonic multiplexer/demultiplexer through the optical path, and then is output to the optical engine, thus enabling the optical engine to perform gain processing on the optical signal and perform downlink transmission via the optical interface.

The uplink optical signal received via the optical interface is subjected to gain amplification in the optical engine and then enters the silicon photonic PIN receiver via the silicon photonic multiplexer/demultiplexer for photoelectrical conversion for output.

In a possible implementation, when the driving electrical signals are two paths of driving electrical signals, the transceiver integrated chip includes:
a silicon photonic coupler, a silicon-based optical splitter, two silicon photonic modulators, two silicon photonic multiplexers/demultiplexers, and two silicon photonic PIN receivers.

Each silicon photonic multiplexer/demultiplexer of the transceiver integrated chip needs to support the multiplexing and demultiplexing of two optical signals with different wavelengths: single downlink and single uplink.

The silicon photonic coupler is configured to receive a laser signal which is transmitted from a laser component in the optical engine and serves as a downlink light source, and the downlink light source is subjected to optical splitting processing by the silicon-based optical splitter to form two paths of downlink light sources.

Each path of downlink light source is transmitted via the optical path into the respective corresponding silicon photonic modulator for modulation, and each silicon photonic modulator is configured to modulate the path of downlink light source based on one path of driving electrical signal, so as to obtain one path of modulated optical signal.

The two paths of modulated optical signals are transmitted via optical paths to the respective silicon photonic multiplexers/demultiplexers and then are output to the optical engine, respectively, thus enabling two gain components of the optical engine to perform gain processing on two paths of outputs and perform downlink transmission of the two paths of optical signals via the optical interface.

The two paths of uplink optical signals received via the optical interface, after being subjected to gain amplification respectively in the two gain components of the optical engine, enter the respective silicon photonic multiplexers/demultiplexers for processing, and then are transmitted via the optical paths to the respective silicon photonic PIN receivers for photoelectric conversion; and each silicon photonic PIN receiver is configured to output one path of converted electrical signal.

In a possible implementation, when the driving electrical signals are two paths of driving electrical signals, the transceiver integrated chip includes:
two silicon photonic couplers, two silicon photonic modulators, a silicon photonic multiplexer/demultiplexer, and two silicon photonic PIN receivers.

Each silicon photonic coupler is configured to receive a laser signal which is transmitted from a corresponding laser component in the optical engine and serves as a downlink light source, laser signals respectively corresponding to the two paths of downlink light sources have different wavelengths, and a spacing distance between the two wavelengths is greater than 10 nm; the downlink light sources are transmitted via optical paths into the respective corresponding silicon photonic modulators for modulation, and each silicon photonic modulator is configured to modulate the path of downlink light source based on one path of driving electrical signal.

The two paths of modulated optical signals having different wavelengths, after being transmitted via the optical paths to one silicon photonic multiplexer/demultiplexer, enter a gain component of the optical engine for gain amplification, and then is coupled into an optical fiber via the SC optical interface for the downlink transmission of two paths of optical signals.

The two paths of uplink optical signals having different wavelengths received via the optical interface, after being subjected to gain amplification in one gain component of the optical engine, are processed by the silicon photonic multiplexer/demultiplexer into two paths of spatially separated uplink optical signals, each path of uplink optical signal is transmitted via the optical path to the respective silicon photonic PIN receiver for photoelectric conversion, and each silicon photonic PIN receiver is configured to output one path of converted electrical signal. The wavelengths of the two paths of uplink optical signals in the implementation are different from those of two downlink optical signals.

In a possible implementation, when the driving electrical signals are four paths of driving electrical signals, the transceiver integrated chip includes:
two silicon photonic couplers, two silicon-based optical splitters, four silicon photonic modulators, two silicon photonic multiplexer/demultiplexers, and four silicon photonic PIN receivers.

The two silicon photonic couplers are configured to respectively receive laser signals which are transmitted from two laser components in the optical engine and serve as downlink light sources, the two laser signals have different wavelengths, and the downlink light sources are subjected to optical splitting processing via the silicon-based optical splitters to form four paths of downlink light sources, wavelengths of which are consistent in pairwise.

Each path of downlink light source is transmitted via the optical path into the respective corresponding silicon photonic modulator for modulation, and each silicon photonic modulator is configured to modulate the path of downlink light source based on one path of driving electrical signal, so as to obtain one path of modulated optical signal.

The four paths of modulated optical signals are transmitted via the optical paths to the silicon photonic multiplexers/demultiplexers, and two optical signals with different wavelengths are taken as a group, a total of two groups is output to the optical engine by the two silicon photonic multiplexers/demultiplexers, respectively, thus enabling two gain components of the optical engine to perform gain processing on the outputs of four paths of optical signals in two groups and perform downlink transmission of the optical signals via the duplex optical LC optical interface.

The four paths of uplink optical signals received via the optical interface, after being subjected to gain amplification respectively in the two gain components of the optical engine, enter the respective silicon photonic multiplexers/demultiplexers for processing, and then are transmitted via the optical paths to the respective silicon photonic PIN receivers for photoelectric conversion, and each silicon photonic PIN receiver is configured to output one path of converted electrical signal.

In a possible implementation, when the driving electrical signals are four paths of driving electrical signals, the transceiver integrated chip includes:
four silicon photonic couplers, four silicon photonic modulators, one silicon photonic multiplexer/demultiplexer, and four silicon photonic PIN receivers.

Each silicon photonic coupler is configured to receive a laser signal which is transmitted from a corresponding laser component in the optical engine and serves as a downlink light source, the four paths of laser signals have different wavelengths, the downlink light sources are transmitted via optical paths into the respective corresponding silicon photonic modulators for modulation, and each silicon photonic modulator is configured to modulate the path of downlink light source based on one path driving electrical signal, so as to obtain one path of modulated optical signal.

The four paths of modulated optical signals are transmitted via the optical paths to one silicon photonic multiplexer/demultiplexer for spatial multiplexing, and then enter an on-chip waveguide to output four paths of downlink optical signals to the optical engine, thus enabling one gain component of the optical engine to perform gain processing on four paths of outputs and perform downlink transmission of the four paths of optical signals via the Simplex SC optical interface.

The four paths of uplink optical signals received via the optical interface, after being subjected to gain amplification in one gain component of the optical engine, enter an on-chip waveguide on the silicon-based optoelectronic integrated chip, and then the four optical signals, after being processed by one silicon photonic multiplexer/demultiplexer, enter four on-chip waveguides according to different wavelengths to form four paths of spatially separated uplink optical signals, each path of uplink optical signal is transmitted via the optical path to the respective silicon photonic PIN receiver for photoelectric conversion, and each silicon photonic PIN receiver is configured to output one path of converted electrical signal.

In a possible implementation, the transceiver integrated chip further includes a silicon photonic waveguide and a silicon photonic monitor which correspond to optical path transmission.

The silicon photonic waveguide and the silicon photonic monitor are configured to transmit and monitor an optical signal subjected to optical path transmission.

In a second aspect, it is further provided an optical engine for a PON OLT system according to an embodiment of the present disclosure. The optical engine is located in an OLT component employing an SFP-DD (Small Form-factor Pluggable-Double Density) or a SFP-DD112 (Small Form-factor Pluggable-Double Density 112G) package, and is configured to modulate a downlink optical signal based on single path/two paths/four paths of driving electrical signals generated by a modulation driving component in an OLT component, and the modulated downlink optical signal is transmitted through an optical interface of the optical engine after gain processing.

An uplink light signal received by the optical interface of the optical engine is subjected to photoelectric conversion and then transmitted to a burst mode receiving and amplifying chipset of the OLT component located on an external region of the optical engine for processing.

The optical engine is internally provided with any silicon-based optoelectronic transceiver integrated chip in the first aspect.

In a possible implementation mode in the second aspect, the optical interface of the optical engine is configured to receive an uplink optical signal or transmit a downlink optical signal. The optical interface includes a single-channel Bi-directional Simplex SC (Standard Connector) interface and/or a dual-channel Bi-directional Dual-Simplex LC (Lucent Connector) interface. The optical interface is used for an optical component in an SFP-DD/SFP-DD112 package mode.

In a possible implementation mode in the second aspect, the optical engine includes:
a silicon-based optoelectronic transceiver integrated chip, a O-band laser and driving component, a O-band gain chip and driving component, an optical interface, and a gold finger array.

The O-band laser and driving component is used as a laser component to generate a laser signal serving as a downlink light source; the O-band gain chip and driving component is configured to perform gain processing on an optical signal output by the silicon-based optoelectronic transceiver integrated chip, or to perform gain processing on the uplink optical signal received by the optical interface; the gold finger array is configured to transmit electrical signals/driving electrical signals of other components in the optical engine and OLT.

When the driving electrical signal is one path of driving electrical signal, there is one O-band laser and driving component, and one O-band gain chip and driving component.

When the driving electrical signals are two paths of driving electrical signals, there is one O-band laser and driving component, and two O-band gain chip and driving components.

When the driving electrical signals are two paths of driving electrical signals, there are two O-band laser and driving components, and two O-band gain chip and driving components.

When the driving electrical signals are two paths of driving electrical signals, there are two O-band laser and driving components, and one O-band gain chip and driving component.

When the driving electrical signals are four paths of driving electrical signals there are two O-band laser and driving components, and two O-band gain chip and driving components.

When the driving electrical signals are four paths of driving electrical signals, there are four O-band laser and driving components, and one O-band gain chip and driving component.

In a third aspect, it is further provided a multi-rate central office module based on a silicon-based optoelectronic integrated chip according to an embodiment of the present disclosure. The central office module is a component employing an SFP-DD/SFP-DD112 package, and includes an electrical interface, an analog/digital signal processing integrated component with multi-rate combination of single/dual/four paths, an optical engine, and a burst mode receiving and amplifying chipset with multi-rate combination of single/dual/four paths.

The electrical interface is configured to achieve electrical signal transmission between the central office module and a system board.

The analog/digital signal processing integrated component is configured to perform clock data recovery, rate and/or pattern conversion processing on a downlink electrical signal with a first parameter transmitted by the system board through the electrical interface of the optical component, so as to obtain an electrical signal with a second parameter, which is used for being applied to an optical signal corresponding to the silicon-based optoelectronic integrated chip in the optical engine to achieve the modulation of the optical signal, and the modulated downlink optical signal is transmitted via an optical interface of the optical engine to a network end.

The uplink optical signal received by means of the optical interface of the optical engine is converted into an electrical signal by the receiving of the silicon-based optoelectronic integrated chip in the optical engine; and the electrical signal is transmitted via the burst mode receiving and amplifying chipset and the electrical interface to the system board.

The silicon-based optoelectronic integrated chip in the optical engine is a transceiver integrated chip for achieving the integration of the transmitting and receiving of optical signals.

In a possible implementation mode of the third aspect, the silicon-based optoelectronic integrated chip in the optical engine is any silicon-based optoelectronic transceiver integrated chip for the PON OLT system in the first aspect.

In a possible implementation mode of the third aspect, the optical engine is any optical engine for the PON OLT system in the second aspect.

In a possible implementation mode of the third aspect, the electrical interface includes a gold finger array of a printed circuit board of the SFP-DD/SFP-DD112 package.

The burst mode receiving and amplifying chipset includes a burst mode receiving trans-impedance amplifier, and a burst mode receiving linear amplifier.

When the electrical signal with the second parameter is one path of electrical signal, there is one path of input-output burst mode electrical signals of the burst mode receiving and amplifying chipset, and the rate of the path of electrical signal of the burst mode receiving and amplifying chipset is equal to or lower than that of the electrical signal with the second parameter.

When the electrical signals with the second parameter are two paths of electrical signals, there are two paths of input-output burst mode electrical signals of the burst mode receiving and amplifying chipset, and the rates of the two paths of electrical signals of the burst mode receiving and amplifying chipset are not higher than that of the electrical signal with the second parameter.

When the electrical signals with the second parameter are four paths of electrical signals, there are four paths of input-output burst mode electrical signals of the burst mode receiving and amplifying chipset, and the rates of the four paths of electrical signals of the burst mode receiving and amplifying chipset are not higher than that of the electrical signal with the second parameter.

In a possible implementation mode of the third aspect, the electrical interface is configured to achieve the connection between a 25/50/100/200G PON OLT system and/or a 25/50/100/200G EPON (Ethernet Passive Optical Network) OLT system and the central office module, and the electrical interface includes one or more of the following interfaces: a single-path electrical interface, a dual-path electrical interface, and a four-path electrical interface.

In a possible implementation mode of the third aspect, an analog/digital signal processing integrated component includes a digital process chip DSP, and a modulation driving component for optical signal modulation of a silicon photonic chip;
the DSP is configured to perform clock data recovery, rate and/or pattern mapping conversion on a single path of electrical signal or two paths of electrical signals, i.e., the first parameter, transmitted by the electrical interface according to the parameters of optical transmission equipment, so as to obtain one path of downlink electrical signal meeting transmission parameter requirements of the optical transmission equipment, and one path of driving electrical signal, i.e., the second parameter, is obtained through the modulation driving component;
and/or
a digital processing chip DSP and a modulation driving component for optical signal modulation of a silicon photonic chip;
the DSP is configured to perform clock data recovery, rate and/or pattern mapping conversion on two paths of electrical signals transmitted by the electrical interface according to the parameters of optical transmission equipment, so as to obtain two paths of downlink electrical signals meeting transmission parameter requirements of the optical transmission equipment, and two paths of driving electrical signals, i.e., the second parameter, are obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain single path of downlink electrical signal meeting transmission parameter requirements of the optical transmission equipment, and single path of single driving electrical signal, i.e., the second parameter, is obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain two paths of downlink electrical signals meeting transmission parameter requirements of the optical transmission equipment, and two paths of driving electrical signals, i.e., the second parameter, are obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain four paths of downlink electrical signals meeting transmission parameter requirements of the optical transmission equipment, and the four paths of driving electrical signals, i.e., the second parameter, are obtained through the modulation driving component;
and/or
an analog/digital signal processing integrated component includes: a dual-path retimer component and a modulation driving component for optical signal modulation;
the dual-path retimer component is configured to perform clock data recovery, rate and/or pattern mapping conversion on two paths of electrical signals transmitted by the electrical interface according to the parameters of optical transmission equipment, so as to obtain two paths of downlink electrical signals meeting transmission parameter requirements of the optical transmission equipment, and two paths of driving electrical signals are obtained through the modulation driving component;
and/or
an analog/digital signal processing integrated component includes a four-path retimer component and a modulation driving component for optical signal modulation;
the four-path retimer component is configured to perform clock data recovery, rate and/or pattern mapping conversion on four paths of electrical signals transmitted by the electrical interface according to the parameters of optical transmission equipment, so as to obtain four paths of downlink electrical signals meeting transmission parameter requirements of the optical transmission equipment, and four paths of driving electrical signals are obtained through the modulation driving component. In actual application, the rates of the four paths may be consistent, for example, the four channel may all employ the rates of 4×25 Gbps, 4×50 Gbps and 4×100 Gbps; or in other embodiments, every two of the four paths may employ the consistent rate, for example, the combination of 2×25 Gbps+2×50 Gbps. The rate is not limited in this embodiment, and can be selected according to actual needs.

In a possible implementation mode of the third aspect, the DSP includes: a Retimer component, a Gearbox component, and a pattern conversion module.

When a single path like 1×25 Gbps or 1×50 Gbps NRZ or 1×100 Gbps PAM4 pattern is input, the Gearbox component of the DSP does not operate, and the single-path Retimer component is configured to perform clock data recovery on the single path of input electrical signal and to output single path like 1×25 Gbps NRZ or 1×50 Gbps NRZ or 1×100 Gbps PAM4 pattern as a downlink electrical signal.

When two paths like 2×25 Gbps NRZ patterns are input, the Retimer component and the Gearbox component are configured to map and convert two paths of input electrical signals 2×25 Gbps NRZ into a single path of 50 Gbps NRZ pattern, so as to serve as one path of output downlink electrical signal.

When two paths like 2×25 Gbps NRZ patterns are input, the Retimer component, the Gearbox component and the pattern conversion module are configured to map and convert two paths of input signals 2×25 Gbps NRZ into a single path of 50 Gbps PAM4 pattern, so as to serve as one path of output downlink electrical signal.

When two paths like 2×50 Gbps NRZ patterns are input, the Retimer component and the Gearbox component are configured to map and convert two paths of input electrical signals 2×50 Gbps NRZ into a single path of 100 Gbps NRZ pattern, so as to serve as one path of output downlink electrical signal.

When two paths like 2×50 Gbps NRZ patterns are input, the Retimer component, the Gearbox component and the pattern conversion module are configured to map and convert two paths of input signals 2×50 Gbps NRZ into a single path of 100 Gbps PAM4 pattern, so as to serve as one path of output downlink electrical signal.

When two paths like 2×100 Gbps PAM4 patterns are input, the Retimer component and the Gearbox component are configured to map and convert two paths of input electrical signals 2×100 Gbps PAM4 into a single path like 1×200 Gbps PAM4 pattern, so as to serve as one path of output downlink electrical signal.

In a possible implementation mode of the third aspect, the dual-path retimer component includes: a retimer chip.

When two paths like 2×25 Gbps NRZ patterns are input, the retimer chip is configured to perform clock data recovery on two paths of electrical signals received by the electrical interface and to map and convert the electrical signals into two paths of 25 Gbps NRZ patterns, so as to serve as two paths of output downlink electrical signals.

When the two paths are input using different rate modes, one path is a 25 Gbps NRZ pattern while the other is a 50 Gbps NRZ pattern, the retimer or the DSP chip is configured to perform clock data recovery on two paths of electrical signals received by the electrical interface and to map and convert the electrical signals into one path of 25 Gbps NRZ pattern and one path of 50 Gbps NRZ pattern, so as to serve as two paths of output downlink electrical signals.

When two paths like 2×50 Gbps NRZ patterns are input, the retimer or the DSP chip is configured to perform clock data recovery on two paths of electrical signals received by the electrical interface and to map and convert the electrical signals into two paths like 2×50 Gbps NRZ patterns, so as to serve as two paths of output downlink electrical signals.

When two paths like 2×100 Gbps PAM4 patterns are input, the retimer or the DSP chip is configured to perform clock data recovery on two paths of electrical signals received by the electrical interface and to map and convert the electrical signals into two paths like 2×100 Gbps PAM4 patterns, so as to serve as two paths of output downlink electrical signals.

In a possible implementation mode of the third aspect, the four-path retimer or DSP component includes: a retimer chip or DSP chip.

When four paths like 4×25 Gbps NRZ patterns are input, the retimer chip is configured to perform clock data recovery on four paths of electrical signals received by the electrical interface and to map and convert the four paths of electrical signals into four paths of 25 Gbps NRZ patterns, so as to serve as four paths of output downlink electrical signals.

When four paths like 4×25 Gbps NRZ patterns are input, the DSP chip is configured to perform clock data recovery on four paths of electrical signals received by the electrical interface and to map and convert the electrical signals into a single path of 100 Gbps PAM4 pattern, so as to serve as a single path of output downlink electrical signal.

When four paths like 4×25 Gbps NRZ patterns are input, the DSP chip is configured to perform clock data recovery on four paths of electrical signals received by the electrical interface and to map and convert the electrical signals into two paths like 2×50 Gbps NRZ or PAM4 patterns, so as to serve as two paths of output downlink electrical signals.

When four paths like 4×50 Gbps NRZ patterns are input, the retimer or DSP chip is configured to perform clock data recovery on four paths of electrical signals received by the electrical interface and to map and convert the electrical signals into four paths like 4×50 Gbps NRZ patterns, so as to serve as four paths of output downlink electrical signals.

When four paths like 4×50 Gbps NRZ patterns are input, the DSP chip is configured to perform clock data recovery on four paths of electrical signals received by the electrical interface and to map and convert the electrical signals into a single path of 200 Gbps PAM4 pattern, so as to serve as one path of output downlink electrical signal.

When four paths like 4×50 Gbps NRZ patterns are input, the DSP chip is configured to perform clock data recovery on four paths of electrical signals received by the electrical interface and to map and convert the electrical signals into two paths like 2×100 Gbps PAM4 patterns, so as to serve as two paths of output downlink electrical signals.

When four paths like 2×25 Gbps and 2×50 Gbps are input in combination, the retimer or DSP chip is configured to perform clock data recovery on four paths of electrical signals received by the electrical interface and to map and convert the electrical signals into four paths like 2×25 Gbps and 2×50 Gbps NRZ patterns, so as to serve as four paths of output downlink electrical signals.

In a possible implementation mode of the third aspect, the modulation driving component is a silicon photonic modulation driving component, and is integrated into the DSP, or is integrated on a component with the retimer chip.

In a fourth aspect, it is further provided a passive optical network PON OLT system according to an embodiment of the present disclosure, which includes any multi-rate central office module based on the silicon-based optoelectronic integrated chip in the third aspect, and the system interacts with a PON network side through the central office module.

The technical solutions of the embodiments above have advantages and effect as follows:
(1) The optical interface in the OLT of the central office module in each embodiment is different from four optical interface types defined by an existing SFP-DD/SFP-DD112MSA protocol (a Duplex LC (Duplex Lucent Connector), an MPO-12 (Multi Fiber Push on 12), an MDC (Mini Duplex Connector), and a SN (SN Connector)). In each embodiment, the SFP-DD/SFP-DD112 package protocol is configured to package a Simplex SC optical interface in the OLT, thus enabling the Simplex SC optical interface to support single-channel Bi-directional (BiDi) transmission of optical signals in the PON. Mutually independent dual-channel Simple LC optical interface can be employed in each embodiment, thus doubling the port density of the PON OLT system board to achieve higher-density Bi-directional transmission characteristics.
(2) In the technical solution of each embodiment, the current high-speed minimized SFP-DD/SFP-DD112 package protocol is applied to an electrical interface for the interaction of system boards, so as to support the demands of port high density and system high performance of the next generation of PON OLT system. Under the help of the PON OLT system in each embodiment, the operators can achieve the increase of the downlink rate of an access network from the current 10 Gbps of XG(S)PON to higher bandwidths, such as 25 Gbps, 50 Gbps and 100 Gbps, and the increase of the uplink rate from 10 Gbps to 25G or 50 Gbps by using the central office module.
(3) Applying the central office module in each embodiment to the PON OLT system can achieve higher board throughput. Specifically, the XG(S) PON OLT system may support sixteen 10 Gbps PON OLT SFP+optical transceivers (i.e., central office modules/central office equipment). In the central office module employing the electrical interface of the SFP-DD/SFP-DD112 package with one path of electrical signal of each embodiment, the number of optical transceivers inserted into the PON OLT system is unchanged, while the total throughput of the system board in the PON OLT system is increased to 2.5 to 20 times that of the XG(S) PON board.

Especially under a mode of two paths of electrical signals, one SFP-DD/SFP-DD112 board is equivalent to thirty-two optical transceivers of the SFP-DD/SFP-DD11225G/50G/100G PON, and the total throughput of the system board is further doubled to 5 to 20× of the maximum throughput of the XG(S)PON board.

Under a mode of four paths of electrical signals, sixteen SFP-DD/SFP-DD112100G/200G TWDM PON optical transceivers or thirty-two equivalent SFP-DD/SFP-DD112 50G/25G Combo PON optical transceivers can be plugged into one SFP-DD/SFP-DD112 board.
(4) The central office module in each embodiment can achieve the flexible configuration of the rates of the downlink optical signals, so as to be compatible with more client demands and more different standards.

The PON OLT system of each embodiment supports the operator to flexibly configure the rates of downlink optical signals and related services according to the own client service demands, FTTx (Fiber to the Anything) cost appeals, PONMAC ASIC (Application Specific Integrated Circuit) rates, and SERDES (Serializer/Deserializer) rates. For example, more than ten input-output signal rate combinations can be supported. The OLT/optical transceiver/central office module in each embodiment adopts a structure that is compatible with the different rate requirements and planning of the next generation of PON between operators in China and overseas, the different rate requirements of equipment vendors in China and overseas, and the realization of the next generation of PON technical standards promoted by several international standards organizations.
(5) The central office module in each embodiment is open and extensible for future applications. Specifically, the Ethernet rate-based SFP-DD/SFP-DD112MSA (Multi Source Agreement) increases the support to the single path of 100 G PAM4 input-output. When the PON MAC (Media Access Control) SerDes is upgraded to 100 Gpbs rate in the future, the central office module in each embodiment can be smoothly extended to support TMD (Time Division Multiplexing) or TWDM (Time and Wavelength Division Multiplexing) 200G (E) PON, and 100G/50G or 50G/25G Combo PON. In each embodiment, more than thirteen high- rate PON types are supported.
(6) The central office module in each embodiment is firstly configured to apply the optical engine based on the silicon-based optoelectronic integrated chip to the optical connection of PON network. For the optical engine in the central office module in each embodiment, the conventional optoelectronic hybrid integrated BOSA package is replaced with the integrated silicon-based optoelectronic integrated transceiver chip (SiP: Silicon Photonics), thus effectively avoiding the process complexity caused by using dozens of discrete high-speed optoelectronic chips for hybrid integrated package, improving the product yield, reducing the cost, reducing the total power consumption of the optical transceiver, and improving the product reliability. The optical engine has the characteristics of high performance, high integration, high reliability, is suitable for miniaturized package, and is applicable to future PON OLT systems with higher performance and higher port density.
(7) The silicon-based optoelectronic integrated chip used in the central office module in each embodiment is achieved by a transceiver integrated chip mode, in which the receiving end uses a low-cost and high-performance GeSi PIN receiver. Compared with the conventional PON which adopts an APD (Avalanche Photo Diode) receiver, the PIN receiver has low cost and high yield, and is fully compatible with the transmitting end silicon photonic process and the silicon-based MZ modulator process, and the transceiver integrated chip can be tape-out once in the existing mature silicon photonic process production line. The fabrication of key silicon photonics integrated chips can be completed without upgrading the processing and fabricating equipment and precision of the existing silicon photonic industry.
(8) In the central office module, the O-band gain chip integrated with the SiP is configured to amplify a transmitting side high-power optical signal and a receiving-side low-power optical signal of the central office module (i.e., the optical transceiver) simultaneously. For the defects that the own receiving sensitivity of the GeSi PIN is inferior to the receiving sensitivity of the APD and the PON uplink signal may have been attenuated to below the sensitivity of the PIN receiver after long distance transmission, the central office module in each embodiment is configured to amplify the received signal by using the integrated O-band gain chip, so as to meet the own sensitivity requirement of the Germanium-silicon PIN receiver and compensate for the high dispersion cost of the optical signals with different wavelengths at different ultra-high rates caused by transmission fibers. That is, a PIN+Gain Chip integration mode is configured to replace the conventional APD, and is applied to the next generation of PON optical network, which is a result of comprehensive consideration of many factors, such as meeting technical standards, optimizing the cost of the optical engine of optical transceiver, and being compatible with existing mature silicon photonic technology.

In conclusion, the OLT central office equipment used in the passive optical network PON in each embodiment supports the miniaturized SFP-DD/SFP-DD112 package, thus effectively supporting the port high-density and high-performance demand of the next generation of OLT system equipment. Correspondingly, the existing configuration of sixteen pluggable optical transceiver ports on a PON board can be allowed to be maintained in a PON OLT system, the port density of the board remains unchanged, but the throughput of the board is increased to 2.5 to 20× that of the current 10GPON board. Further, the distribution of double rows of gold fingers of the SFP-DD/SFP-DD112 electrical interface in each embodiment can be downwardly compatible with a single row of gold fingers of the SFP28/SFP56/SFP112, and the gold finger array can be flexibly redefined to be compatible with two groups of Combo PON, thus achieving the compatibility of multi-rate channels.

### BRIEF DESCRIPTION OF THE DRAWINGS

FIG. 1 to FIG. 3 each are a schematic diagram of a silicon-based optoelectronic transceiver integrated chip in an embodiment;

FIG. 4 to FIG. 6 each are a schematic diagram of an optical engine in another embodiment;

FIG. 7 is a schematic diagram of an optical interface type defined by SFP-DD/SFP-DD112MSA in the prior art;

FIG. 8 is a schematic diagram of a single-channel Simplex SC optical interface and a dual-channel Simplex LC interface used in another embodiment;

FIG. 9 to FIG. 11 each are a schematic diagram of the functional architecture of a central office module in another embodiment;

FIG. 12 to FIG. 14 each are a schematic diagram of the architecture of a PON OLT system used by the central office module;

FIG. 15 and FIG. 16 each are a schematic diagram of a silicon-based optoelectronic transceiver integrated chip and the belonging optical engine in another embodiment.

In the drawings:
A1—silicon-based optoelectronic transceiver integrated chip; A2—optical engine
1—PON MAC ASIC; 2—electrical interface/electrical interface using SFP-DD/SFP-DD112 protocol
3—DSP/digital processing chip; 4—silicon photonic modulation driver
5—silicon photonic modulator; 6—O-band high-power semiconductor laser;
7—silicon photonic coupler; 8—silicon photonic multiplexer/demultiplexer
9—O-band gain chip; 10—Simplex SC optical interface or Simple LC optical interface
11—silicon photonic PIN receiver; 12—SOA driver
14—burst mode trans-impedance amplifier/BM-TIA; 15—burst mode linear amplifier/BM-LA
16—burst mode clock data recovery SerDes/BM CDR SERDES
17—microprocessor; 18—EEPROM
19—optical transceiver power supply; 20a, 20b, 20c and 20d—on-chip optical monitor of silicon photonic chip
21a, 21b, 21c and 21d—on-chip waveguide; 22—high-power semiconductor laser driver
23—power supply management component; 24—silicon-based optical splitter/silicon-based 1:2 optical splitter
25a, 25b and 25c—micro lens; 26—gold finger array.

### DETAILED DESCRIPTION OF THE EMBODIMENTS

To explain the technical solutions better to facilitate the understanding, the technical solutions are described in detail below through the specific embodiments with reference to the accompanying drawings. The technical solutions described below are not limited to the technical solutions, but are only examples for easy understanding, and the corresponding drawings are provided for explanation.

At present, the global access network is in the transition stage from GPON to 10G(S) PON, which is also the key time for the development and selection of the next generation of PON technology. The rate of the next generation of PON technology is high-speed PON of 50G and 100G. There are some differences between the concepts of 25 Gbps and 50 Gbps used by various standard protocol organizations. For example, the historical tradition that the 25G(S)PON MSA and ITU-T 50GPON follow the ITU-T (International Telecommunication Union Telecommunication Standardization Sector) rate, whose 25 Gbps and 50 Gbps are actually 24.8832 Gbps and 49.7664 Gbps, using the NRZ code. While the 25 Gbps and 50 Gbps of IEEE standard are actually 25.78125 Gbps and 2×25.78125 Gbps NRZ code, following the tradition of Ethernet rate. These subtle differences represent judgments of different standards organizations on the future direction of the industrial chain and different positions of leading the industrial chain through standards, and also lead to industrial chain differentiation. For example, PMA (Physical Media Attachment) and PMD (Physical Media Dependent) layer have established a mature and complete optoelectronic chip industry chain to support the Ethernet standard of 25.78125 Gbps NRZ. For the EPON application based on Ethernet rate, except for a few key electrical chips, the basic units for achieving the physical layer of IEEE 25G/50G-EPON are complete, and the technical span is not large. At present, the current challenges are focused on the application requirements and the achievement of miniaturization and low-power package so as to support the two pairs of 25G different wavelength transceiver chipsets required for 50G-EPON. In the post-25G era, the SerDes rate of Ethernet industry chain has been 56G PAM4 (28G Baud) and 112G PAM4 (56G Baud) using the PMA4 pattern, and the optical interface signal rate is 53.125 Gbps (50 Gbps for short) and 106.25 Gbps (100 Gbps for short) using the PAM4 pattern, so it can be expected that the IEEE PON standard in the post-50G-EPON era may use a PAM4 pattern signal, which is further differentiated from the ITU-T50GPON using the NRZ pattern.

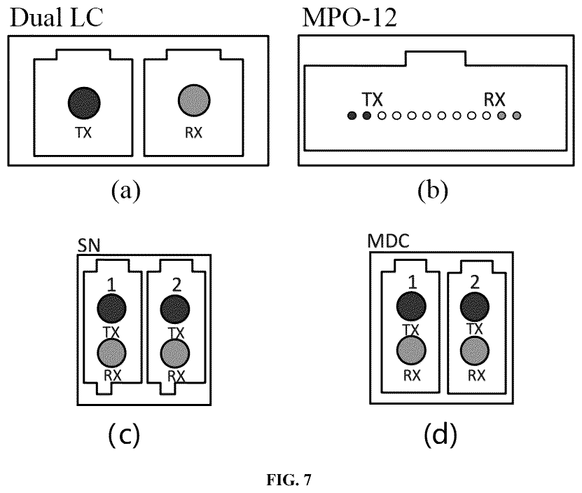

In the GPON and XG(S) PON eras, SFP (Small Form-Factor Pluggable) and SFP+ are typical package modes used for optical transceivers, which allow one OLT board to accommodate sixteen optical transceivers. In addition, seventeen even more boards can be inserted into a shelf of the current high-density and high-performance OLT system. The industry has not yet reached a consensus on which package of optical transceivers to use for the next generation of higher-performance and higher-density OLT systems. In the past 10 years, the fastest development in optical communication network technology and application is Hyper Scale Data Center. In order to support high-density, high-performance, low-power-consumption and low-cost optical interconnection in the data center, the new generation of SPF-BASED SFP-DD/SFP-DD112 MSA protocol defines four optical fiber interface types (Duplex LC (as shown in FIG. 7 (a)), MPO-12 (as shown in FIG. 7 (b)), MDC (as shown in FIG. 7 (d)) and SN (as shown in FIG. 7 (c)). The SFP-DD/SFP-DD112 optical transceiver following the multi-source agreement may flexibly support SerDes rate such as single path of (1×) or two (2×) paths of 25G NRZ, 56G PAM4 (28Gbaud) and 112G PAM4 (56Gbaud) at electrical interfaces, and Ethernet rate of 1×25 Gbps to 2×100 Gbps at optical interfaces.

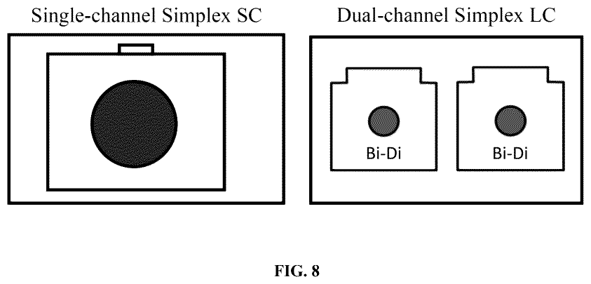

The optical communication network involved in each embodiment is the next generation of passive optical network technology, and the optical transceiver, i.e., the central office module, in each embodiment employs a SFP-DD/SFP-DD112 package, a silicon-based optoelectronic transceiver integrated chip Silicon Photonics (SiP), and a digital signal processing chip DSP (or retimer); and the optical interface employs a single-channel Simplex SC interface (as shown in FIG. 8(a)) or a dual-channel Simplex LC interface (as shown in FIG. 8(b)) to achieve downlink 25G/50G/100G/200GbpsNRZ or PAM4 signals and uplink burst mode 25G/50G/100G/200GbpsNR or PAM4 signals, support the standard protocols such as the next generation of high-performance high-density 25G(S)PON Multi Source Agreement (MSA), ITU-T 9804.3 50GPON, and IEEE 802.3ca(2020)50G-EPON, and expand for future 100G/200GPON applications.

The SFP-DD/SFP-DD112 electrical interface in each embodiment may use the transmitting and receiving of a single path of high-speed electrical signal, or the transmitting and receiving of two paths of high-speed electrical signals, and also can redefine the double rows of gold fingers of the SFP-DD/SFP-DD112 by means of the electrical interface gold fingers defined by the SFP+Combo PON, so as to achieve the support for the transmitting and receiving of a total of four paths of high-speed electrical signals. By taking the mode of four paths of electrical signals as an example, the four paths of high-speed signals can use the same rate, but the wavelength of each path of optical signal is different, so as to achieve 100G/200G TWDM (Time and Wavelength Division Multiplexing) PON of Simplex SC optical interface; or the four paths of high-speed signals employ the same rate, while four paths of optical signals are grouped in pairs, two optical signals in each group have different wavelengths, and the inter-group wavelength scheme is consistent, so as to achieve the dual-density 50G/100G PON of the dual-channel Duplex LC optical interface. When the four paths of high-speed electrical signals are grouped in pairs, and the rates of the two paths of signals in each group are different, the dual-density Combo PON can be supported. For example, one path of 50G and one path of 25G are in one group, the dual-channel 50G/25G Combo PON can be achieved on the SFP-DD/SFP-DD112 optical transceiver, and the Simplex LC interface is configured for each 50G/25G Combo PON optical path port.

In each embodiment in the following, the downlink refers to transmitting TX, the uplink refers to receiving RX, and interfaces for optical signal transmission are all optical interfaces. The central office module in each embodiment is OLT, OLT transceivers and the like. In the description of each embodiment, single path refers to one path of optical signal or electrical signal, dual path refers to two paths of optical signals or electrical signals, and four paths refers to four paths of optical signals or electrical signals; single channel refers to that the optical interface of the optical engine is an optical fiber interface which can transmit/receive at least two paths of optical signals with different wavelengths at the same time; dual channel refers to that the optical interfaces of the optical engine are two optical fiber interfaces, and each interface can transmit/receive at least two paths of optical signals with different wavelengths at the same time.

### Embodiment 1

It is provided a silicon-based optoelectronic transceiver integrated chip for a PON OLT system according to an embodiment. The transceiver integrated chip is located in the optical engine of an OLT and is an integrated chip for achieving the integration of transmitting and receiving, and the transceiver integrated chip is configured to modulate an optical signal based on a single path/two paths/or four paths of driving electrical signals at the front end of the OLT, and the modulated downlink optical signal is subjected to gain processing of the optical engine and then is transmitted via an optical interface of the optical engine.

The transceiver integrated chip is configured to perform photoelectric conversion on an uplink optical signal received by the optical interface of the optical engine and then to transmit the photoelectrically converted uplink optical signal to a burst mode receiving and amplifying chipset of the OLT located on an external region of the optical engine for processing.

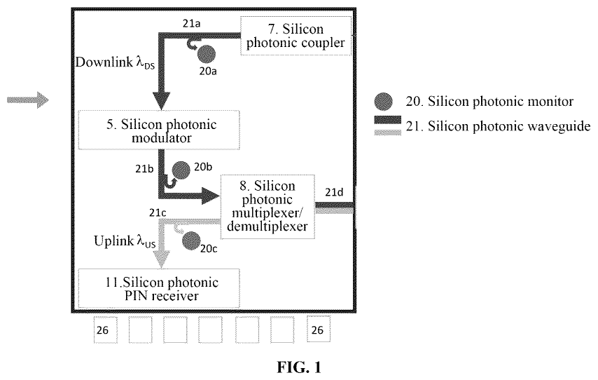

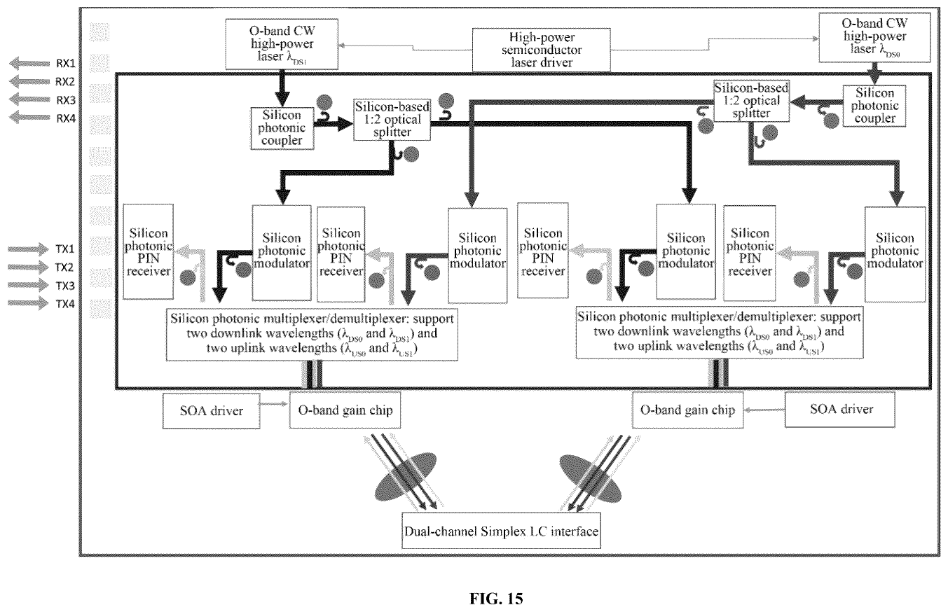

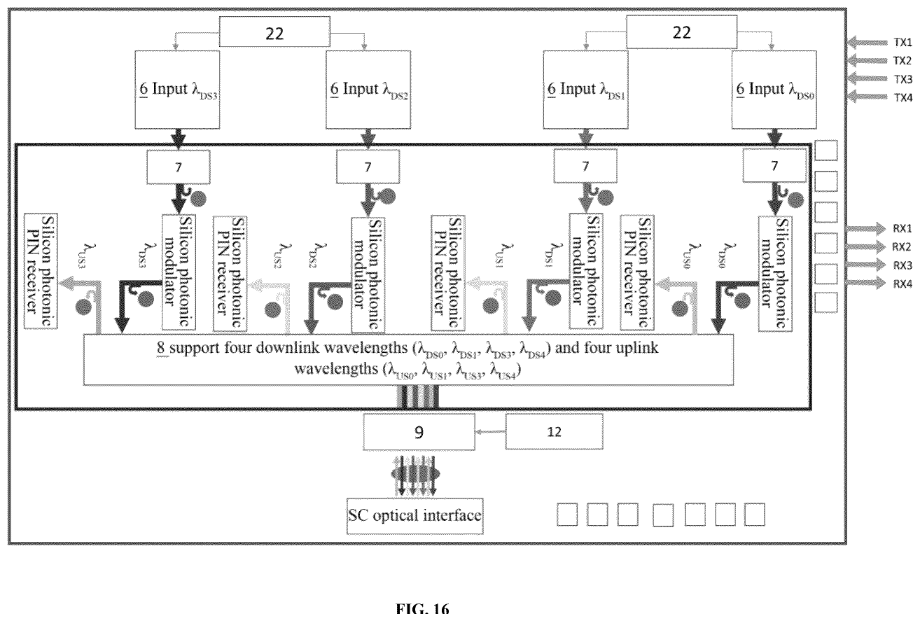

The silicon-based optoelectronic transceiver integrated chip in the embodiment may be a transceiver integrated chip which is fabricated by using a one-time tape-out process and includes a silicon photonic coupler, a silicon photonic modulator, a silicon photonic multiplexer/demultiplexer, and a silicon photonic PIN receiver. The chip also corresponds to a silicon photonic waveguide, a silicon photonic monitor and other components in actual optical path transmission, which can be shown with reference to FIG. 1 to FIG. 3, FIG. 15 and FIG. 16.

During specific application, in a case that the driving electrical signal received by the transceiver integrated chip is one path of driving electrical signal, the modulated downlink optical signal is one path of downlink optical signal.

In a case that the driving electrical signals received by the transceiver integrated chip are two paths of independent driving electrical signals, the transceiver integrated chip is configured to modulate an optical signal based on each path of driving electrical signal, and the modulated downlink optical signals are two paths of downlink optical signals.

In a case that the uplink optical signal received by the optical interface is one path of uplink optical signal, the transceiver integrated chip is configured to perform photoelectric conversion on the path of uplink optical signal and to output one path of converted electrical signal.

In a case that the uplink optical signals received by the optical interface are two paths of uplink optical signals, the transceiver integrated chip is configured to perform photoelectric conversion on the two paths of uplink optical signals and to output two paths of converted independent electrical signals.

In a case that the driving electrical signals are four paths of independent driving electrical signals, the transceiver integrated chip is configured to modulate an optical signal based on each path of driving electrical signal, and the modulated downlink optical signals are four paths of downlink optical signals. Correspondingly, in a case that the uplink optical signals received by the optical interface are four paths of uplink optical signals, the transceiver integrated chip is configured to perform photoelectric conversion on the four paths of uplink optical signals and to output four paths of converted independent electrical signals.

As shown in FIG. 1, the silicon-based optoelectronic transceiver integrated chip A1 may include a silicon photonic coupler 7, a silicon photonic modulator 5, a silicon photonic multiplexer/demultiplexer 8, and a silicon photonic PIN receiver 11.

For the transmission of downlink signals, the silicon photonic coupler 7 is configured to receive a laser signal which is transmitted from a laser component in the optical engine A2 and serves as a downlink light source, the downlink light source is transmitted via an optical path into the silicon photonic modulator 5 for modulation, and the silicon photonic modulator 5 is configured to modulate the downlink light source based on the driving electrical signal, so as to obtain a modulated optical signal.

The modulated optical signal is transmitted via the optical path to the silicon photonic multiplexer/demultiplexer 8, and then is output to the optical engine A2, thus enabling the optical engine to perform gain processing on the optical signal and perform downlink transmission via the optical interface.

For the transmission of uplink signals, the uplink optical signal received via the optical interface is subjected to gain amplification in the optical engine A2 and then enters the silicon photonic PIN receiver 11 via the silicon photonic multiplexer/demultiplexer 8 for photoelectrical conversion for output.

The silicon-based optoelectronic transceiver integrated chip shown in FIG. 1 may achieve the modulation processing of one path of driving electrical signal, which is also a basic unit of the core innovation in this embodiment. In addition, in the optical transmission process in FIG. 1, silicon photonic monitors, i.e., a silicon photonic chip on-chip optical monitors, such as 20a, 20b and 20c, are provided, the monitors have the consistent function with the existing monitor for optical transmission, and in the present disclosure, the monitor is integrated onto the transceiver integrated chip to achieve optical transmission. In addition, silicon photonic waveguides, i.e., on-chip waveguides 21a, 21b, 21c and 21d, have the consistent function with the existing optical waveguide, and are integrated onto the transceiver integrated chip for optical transmission in this embodiment.

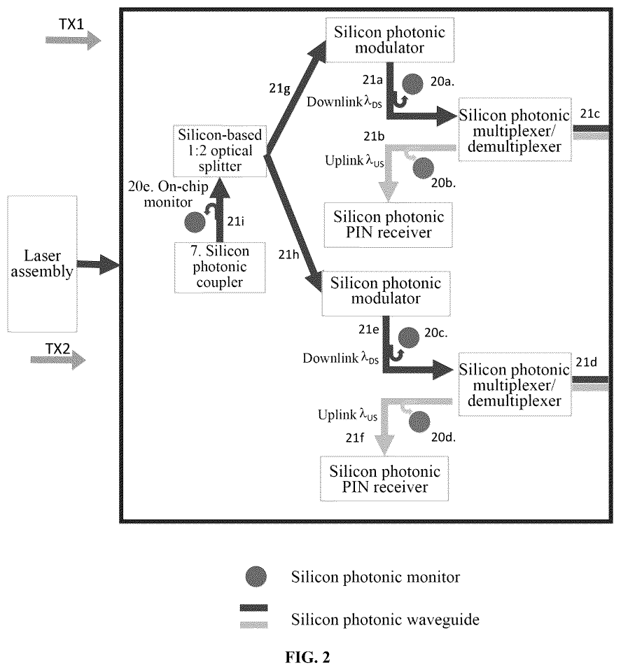

In another possible implementation mode, as shown in FIG. 2, the silicon-based optoelectronic transceiver integrated chip A1 of this embodiment may include a silicon photonic coupler 7, a silicon-based optical splitter 24, two silicon photonic modulators 5, two silicon photonic multiplexers/demultiplexers 8, and two silicon photonic PIN receivers 11.

For two paths of downlink driving electrical signals, the silicon photonic coupler 7 is configured to receive a laser signal which is transmitted from a laser component in the optical engine A2 and serves as a downlink light source, the downlink light source is subjected to optical splitting processing via the silicon-based optical splitter 24 to form two paths of downlink light sources.

Each path of downlink light source is transmitted via the optical path into the respective corresponding silicon photonic modulator 5 for modulation, and each silicon photonic modulator 5 is configured to modulate the path of downlink light source based on one path of driving electrical signal, so as to obtain one modulated optical signal. At the moment, the wavelengths of the two paths of downlink light sources are consistent, and what shown in FIG. 2 is a laser signal generated by one laser component and serving as the downlink light source, which is split into two paths of optical signals by the silicon-based 1:2 optical splitter.

The two paths of modulated optical signals are transmitted via the optical paths to the respective silicon photonic multiplexers/demultiplexers 8, respectively, and then are output to the optical engine A2, respectively, thus enabling two gain components of the optical engine A2 to perform gain processing on two paths of outputs and perform downlink transmission of the two paths of optical signals via the optical interface.

For the uplink optical signals, the two paths of uplink optical signals received via the optical interface, after being subjected to gain amplification respectively in the two gain components of the optical engine, enter the respective silicon photonic PIN receivers for processing, and then are transmitted via the optical path to the respective silicon photonic PIN receivers for photoelectric conversion, and each silicon photonic PIN receiver is configured to output one path of converted electrical signal.

The silicon-based optoelectronic transceiver integrated chip in FIG. 2 can be used in the ITU-T 50GPON with time division multiplexing in terms of rate, the future 100GPON, and various devices with 25G(S)PON MSA protocol with ITU-T PON rate, and two independent optical channels based on FIG. 1 are achieved through the silicon-based optical splitter, which helps the optical engine to achieve dual-channel Bi-directional transmission.

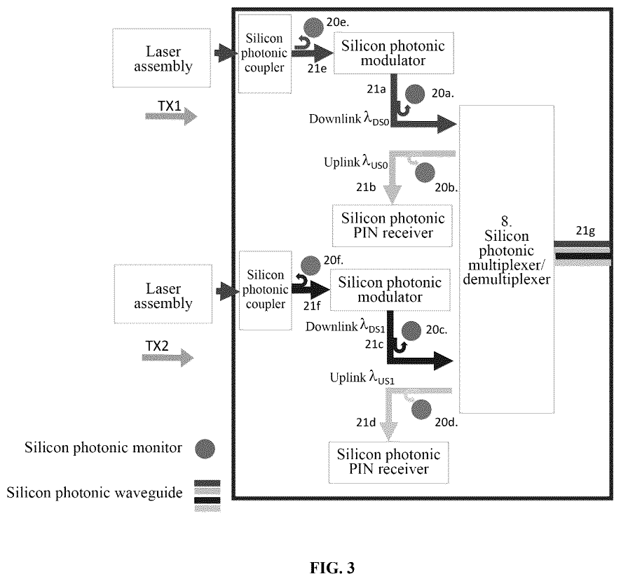

In a third possible implementation mode, as shown in FIG. 3, the silicon-based optoelectronic transceiver integrated chip includes two silicon photonic couplers 7, two silicon photonic modulators 5, one silicon photonic multiplexer/demultiplexer 8, and two silicon photonic PIN receivers 11.

For two paths of downlink driving electrical signals, each silicon photonic coupler 7 is configured to receive a laser signal which is transmitted from a corresponding laser component in the optical engine A2 and serves as a downlink light source, and at the moment, laser signals corresponding to the downlink lights sources have different wavelengths. In FIG. 3, there are two laser components, each laser component transmits a laser signal with one wavelength, and two laser components may transmit laser signals with two wavelengths, such as λ_{DS0} and λ_{DS1}.

Each path of downlink light source is transmitted via the optical path into the respective corresponding silicon photonic modulator 5 for modulation, and each silicon photonic modulator 5 is configured to modulate the path of downlink light source based on one path of driving electrical signal to obtain one path of modulated optical signal.

The two paths of modulated optical signals are transmitted via the optical paths to one silicon photonic multiplexer/demultiplexer 8 for multiplexing, and then two paths of downlink optical signals are output from one port of the silicon photonic multiplexer/demultiplexer 8 to the optical engine A2, thus enabling one gain component of the optical engine to perform gain processing on two paths of outputs and perform downlink transmission of the two paths of optical signals via the optical interface.

For two paths of uplink driving electrical signals, the two paths of uplink optical signals received via the optical interface (the optical signals may be optical signals with different wavelengths, such as an uplink λ_{US0} and a downlink λ_{US1}) are subjected to gain amplification in one gain component of the optical engine, and then are processed by the silicon photonic multiplexer/demultiplexer 8 into two paths of spatially separated uplink optical signals, each path of uplink optical signal is transmitted via the optical path to the respective silicon photonic PIN receiver for photoelectric conversion, and each silicon photonic PIN receiver is configured to output one path of converted electrical signal.

Specifically, based on the structure shown in FIG. 3, the IEEE 50G-EPON have the 2×25 Gbps signal rate and NRZ code, and the transmission and reception of 2×25 Gbps, a total of 50 Gbps, is achieved in a manner of O-band, dual downlink wavelength, and dual uplink wavelength, involving signals with a total of four wavelengths: 1342+/−2 nm, 1358+/−2 nm, 1270+/−10 nm and 1300+/−10 nm. The four wavelengths may be amplified by one O-band gain chip, and the design of the optical engine is simpler. Particularly, the wavelength of the uplink optical signal is different from that of the downlink optical signal, so the wavelengths are illustrated by using lines with different depths in FIG. 3.

Based on the structure of the transceiver integrated chip from FIG. 1 to FIG. 3, silicon photonic waveguides (e.g., 21a, 21b, 21c and 21d and other on-chip waveguides shown in the figures) and silicon photonic monitors (e.g., 20a, 20b, 20c, 20d and other silicon photonic on-chip monitors shown in the figures) for optical path transmission are also provided in the arbitrary optical path transmission. The silicon photonic waveguide and the silicon photonic monitor in this embodiment are configured to transmit and monitor the optical signal subjected to optical path transmission. The silicon photonic on-chip monitor is configured to monitor an optical signal of each device node on the chip, and the silicon photonic on-chip waveguide is configured to achieve high-speed optical signal transmission on the silicon optoelectronic integrated chip.

The silicon optoelectronics integrated chip used in the central office module in this embodiment is achieved by a transceiver integrated chip mode, in which the receiving end employs a low-cost and high-performance GeSi PIN receiver. Compared with the conventional PON which adopts an APD receiver, the PIN receiver has low cost and high yield, and is fully compatible with the transmitting end silicon photonic process and the silicon-based MZ modulator process, and the transceiver integrated chip can be tape-out once in the existing mature silicon photonic process production line. The fabrication of key silicon photonics integrated chips can be completed without upgrading the processing and fabricating equipment and precision of the existing silicon photonic industry.

In a fourth possible implementation mode, it is further provided a transceiver integrated chip for four paths of driving electrical signals according to this embodiment, as shown in the structure in a large rectangular block in FIG. 15. The silicon-based optoelectronic transceiver integrated chip architecture is used for a dual-channel 100G/200G EPON OLT optical transceiver or a dual-channel 50G/25G Combo PON, which has two downlink wavelengths, two uplink wavelengths, a dual-channel Simplex LC interface, two gain chips, and two lasers. Specifically, the transceiver integrated chip includes:
two silicon photonic couplers, two silicon-based optical splitters, four silicon photonic modulators, two silicon photonic multiplexer/demultiplexers, and four silicon photonic PIN receivers.

The two silicon photonic couplers are configured to receive laser signals (the two laser signals have different wavelengths, i.e., the wavelengths of λ_{DS0} and λ_{DS1} in FIG. 15 are different, two groups of λ_{DS0} and two groups of λ_{DS1} exist) which are transmitted from two laser components in the optical engine and serve as downlink light sources, the downlink light sources are subjected to optical splitting processing via the silicon-based optical splitter to form four paths of downlink light sources, wavelengths of which are consistent in pairwise. It needs to be particularly noted that there are also four groups of modulated signals, TX1 to TX4. Each silicon photonic multiplexer/demultiplexer of the transceiver integrated chip needs to support the multiplexing and demultiplexing of the optical signals with two uplink wavelengths and two downlink wavelengths, a total of four different wavelengths. Each path of downlink light source is transmitted via the optical path into the respective corresponding silicon photonic modulator for modulation, and each silicon photonic modulator is configured to modulate the path of downlink light source based on one path driving electrical signal, so as to obtain one path of modulated optical signal.

The four paths of modulated optical signals are transmitted via the optical paths to the silicon photonic multiplexers/demultiplexers, and two paths of optical signals with different wavelengths are taken as a group, a total of two groups is output to the optical engine by the two silicon photonic multiplexers/demultiplexers, respectively, thus enabling two gain components of the optical engine to perform gain processing on the outputs of four paths of optical signals in two groups and perform downlink transmission of the four paths of optical signals via the dual-channel Simplex LC optical interface.

The four paths of uplink optical signals received via the dual-channel Simplex LC optical interface are divided into two groups, each group consists of two paths of optical signals with uplink wavelengths of λ_{US0} and λ_{US1}. The four paths of uplink optical signals, after being subjected to gain amplification respectively in two gain components of the optical engine, enter the respective silicon photonic multiplexer/demultiplexer for processing, and then are transmitted via the optical paths to the respective silicon photonic PIN receivers for photoelectric conversion, and each silicon photonic PIN receiver is configured to output one path of converted electrical signal (e.g., RX1 to RX4 (Receiving)).

That is, in a case that the driving electrical signals are four paths of independent driving electrical signals, the transceiver integrated chip is configured to modulate the optical signal based on each path of driving electrical signal, the modulated downlink optical signals are four paths of downlink optical signals. Correspondingly, in a case that the uplink optical signals received at the optical interface are four paths of uplink optical signals, the transceiver integrated chip is configured to perform photoelectric conversion on four paths of uplink optical signals and output four paths of converted independent electrical signals.

In a fifth possible implementation mode, it is further provided a transceiver integrated chip for four paths of driving electrical signals according to this embodiment, as shown in the structure in a large rectangular block in FIG. 16. The silicon-based optoelectronic transceiver integrated chip architecture is used for a 100G/200G TWDM-PON OLT optical transceiver, which may have four downlink wavelengths, four uplink wavelengths, a Simplex SC interface, a O-band gain chip, and four O-band lasers. Specifically, the transceiver integrated chip includes:
four silicon photonic couplers, four silicon photonic modulators, one silicon photonic multiplexer/demultiplexer, and four silicon photonic PIN receivers.

Each silicon photonic coupler is configured to receive a laser signal which is transmitted from a corresponding laser component in the optical engine and serves as a downlink light source, the downlink light sources are transmitted via optical paths into the respective corresponding silicon photonic modulators for modulation, and each silicon photonic modulator is configured to modulate the path of downlink light source based on one path driving electrical signal, so as to obtain one path of modulated optical signal.

The four paths of modulated optical signals are transmitted via the optical paths to one silicon photonic multiplexer/demultiplexer for multiplexing, and then enter an on-chip waveguide, and then four paths of downlink optical signals are output to the optical engine, thus enabling one gain component of the optical engine to perform gain processing on four paths of outputs and perform downlink transmission of the four paths of optical signals via the optical interface. It needs to be noted that four downlink optical wavelengths λ_{DS0}, λ_{DS1}, λ_{DS2} and λ_{DS3} are generated as four lasers are used in the optical engine. The silicon photonic multiplexer/demultiplexer of the transceiver integrated chip needs to support the multiplexing and demultiplexing of the optical signals with four downlink wavelengths and four uplink wavelengths, a total of eight different wavelengths.

Certainly, the four paths of uplink optical signals received via the optical interface, after being subjected to gain amplification in one gain component of the optical engine, are processed by one silicon photonic multiplexer/demultiplexer, and then enter four different on-chip waveguides according to different wavelengths to form four paths of spatially separated uplink optical signals (as λ_{US0}, λ_{US1}, λ_{US2} and λ_{US3} in FIG. 16), each path of uplink optical signal is transmitted via the optical path to the respective silicon photonic PIN receiver for photoelectric conversion, and each silicon photonic PIN receiver is configured to output one path of converted electrical signal.

For example, the silicon photonic multiplexer/demultiplexer in each embodiment above may achieve monolithic integration with other functions, such as an on-chip waveguide, a silicon photonic modulator, a silicon photonic receiver and an optical splitter, on the silicon photonic integrated chip.

For the optical engine of central office module of the embodiment, the conventional optoelectronic hybrid integrated BOSA package is replaced with the silicon-based optoelectronic integrated transceiver chip (SiP), thus effectively avoiding the process complexity caused by using dozens or even hundreds of discrete high-speed photoelectric chips for hybrid integrated package, improving the product yield, reducing the cost, reducing the total power consumption of the optical transceiver and improving the product reliability. The optical engine has the characteristics of high performance, high integration, high reliability, is suitable for miniaturized package, and is applicable to future PON OLT systems with higher performance and higher port density.

Therefore, on the board corresponding to the central office module using the transceiver integrated chip, under the mode of four paths of electrical signals, sixteen SFP-DD/SFP-DD112 100G or 200G TWDM PON optical transceivers or thirty-two equivalent SFP-DD/SFP-DD112 100G/50G or 50G/25G Combo PON optical transceivers can be plugged into one board based on the SFP-DD/SFP-DD112 package, thus improving the throughput, achieving flexible configuration of the downlink optical signal rate, and being compatible with multiple client needs and different standards.

The above embodiments can be applied to 50G/100G/200G OLT pluggable PON optical modules in the future, and can employ the rate combination (Combo) mode (just as that the downlink transmission in the same OLT optical component may use the combination of different rates of 25G+50G, the combination of different rates of 50G+100G, and the like, it is unnecessary to use the same rate), so the OLT component must be provided with a multi-rate burst mode receiving and amplifying chipset for processing multiple paths of 25G/50G/100Gbps. With the help of the burst mode receiving and amplifying chipset, the processing of various burst data of the optical network terminal ONU is achieved.

### Embodiment 2

It is provided an optical engine for a PON OLT system according to this embodiment. The optical engine of this embodiment is applied to the optical connection of the PON network. The optical engine is connected to the PON light transmitting-receiving component, i.e., an optical component, in a pluggable manner, and the optical component in the following embodiment is plugged into an array slot on a PON OLT system panel, thus achieving the optical connection of the PON network. Therefore, high integration and small package can be effectively achieved to solve the problem of high cost and difficult package caused by an existing hybrid package-to-package combined structure.

The optical engine is located in an OLT component, i.e., an optical transceiver, employing an SFP-DD/SFP-DD112 protocol, and is configured to perform modulation and gain processing on an optical signal based on a single path/two paths/four paths of driving electrical signals at the front end of the OLT, and the optical signal after modulation and gain processing is transmitted via an optical interface of the optical engine.

An uplink light signal received by the optical interface of the optical engine is subjected to photoelectric conversion and then transmitted to a burst mode receiving and amplifying chipset of the OLT located on an external region of the optical engine for processing. The optical engine in the embodiment is provided with a silicon-based optoelectronic transceiver integrated chip as arbitrarily described in embodiment 1 (as shown in FIG. 1 through 3, FIG. 15 and FIG. 16).

The transceiver integrated chip is configured to modulate an optical signal based on a single path/dual path of driving electrical signal at the front end of the OLT, and the modulated downlink optical signal is subjected to gain processing of the optical engine and then is transmitted via an optical interface of the optical engine. The transceiver integrated chip is configured to perform photoelectric conversion on an uplink optical signal received by the optical interface of the optical engine and then to transmit the photoelectrically converted uplink optical signal to a burst mode receiving and amplifying chipset of the OLT located on an external region of the optical engine for processing.

In this embodiment, for the optical engine, the the conventional optoelectronic hybrid integrated BOSA package is replaced with a silicon-based optoelectronic integrated transceiver chip (SiP), thus effectively avoiding the process complexity caused by using multiple discrete high-speed photoelectric chips for hybrid integrated packaging, improving the product yield, reducing the cost, reducing the total power consumption of the optical transceiver and improving the product reliability. Thus, the optical engine has the characteristics of high performance, high integration, high reliability, is suitable for miniaturized package, and is applicable to future PON OLT systems with higher performance and higher port density.

In actual application, the optical interface of the optical engine A2 in this embodiment may be configured to receive an uplink optical signal or transmit a downlink optical signal, for example, the optical interface may include a single-channel Bi-directional Simplex SC interface and/or a dual-channel Bi-directional Dual-Simplex LC interface, as shown in FIG. 8.

Moreover, the optical interface is an interface packaged by using an SFP-DD/SFP-DD112 module.

It may be understood that the current optical interface is different from four optical interface types (Duplex LC, MPO-12, MDC, SN, as shown in FIG. 7) defined by the existing SFP-DD/SFP-DD112MSA protocol. In this embodiment, the Simplex SC optical interface in the OLT is packaged by using the SFP-DD/SFP-DD112 package protocol, thus making the Simplex SC optical interface support the single-channel Bi-directional (Bi-direction, BiDi for short) transmission of the optical signal in the PON. Meanwhile, in this embodiment, the dual-channel Simplex LC optical interface can be packaged by using the SFP-DD/SFP-DD112 package protocol, thus making the dual-channel Simplex LC optical interface support the Bi-directional transmission characteristic of the multi-port high-density PON OLT system.

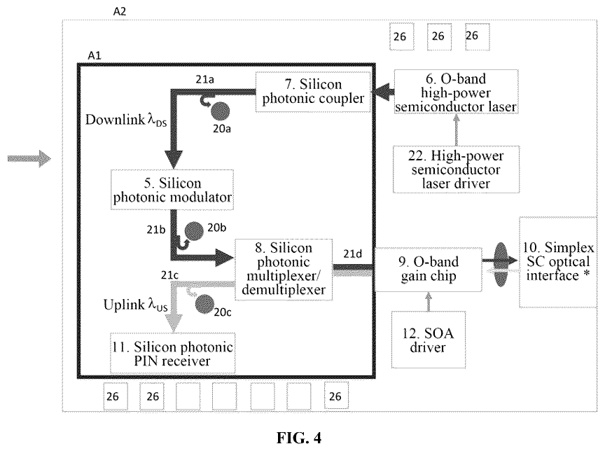

The optical interface shown in FIG. 4 through FIG. 6 is a single-channel Simplex SC or dual-channel Simplex LC (Bi-Direction) optical interface. The dual-channel Simplex LC PON optical transceiver supports the OLT system with higher density and higher performance: on the premise of remaining the PON MAC Serdes rate unchanged, compared with a PON board using the single-channel SC optical interface module, the total throughput of the PON board can be doubled. For example, one PON board, which can support up to sixteen SC ports (channels) SFP series PON OLT optical transceivers in the past, not can support and accommodate thirty-two high-speed LC optical interface PON transmitting-receiving channels. When the PON MAC SerDes rate is upgraded to 100 Gbps (PAM4) in the future, the dual-port 2×100GPON can be smoothly supported through this scheme.

Specifically, referring to FIG. 4 through FIG. 6, the optical engine A2 in this embodiment mainly includes an O-band laser and driving component (e.g., a O-band high-power semiconductor laser 6, a high-power semiconductor laser driver 22), a O-band gain chip and driving component (a O-band gain chip 9, and a SOA driver 12), an optical interface (e.g., Simplex SC optical interface 10), and a gold finger array 26.

In the signal transmitting and receiving process of the optical engine A2, the O-band laser and driving component serves as a laser component to generate a laser signal serving as a downlink light source; the O-band laser and driving component is configured to perform gain processing on an optical signal output by the silicon-based optoelectronic transceiver integrated chip, or to perform gain processing on an uplink optical signal received by the optical interface; and the gold finger array is configured to transmit electrical signals/driving electrical signals of the optical engine and other components in the OLT.

As shown in FIG. 4, when the driving electrical signal at the front end of the OLT is one path of driving electrical signal, there is one O-band laser and driving component, and one O-band gain chip and driving components is one. Such a mode of inputting through a single laser and outputting one path can be used for 25G(S) PON, ITU-T50GPON, or single path of 100GPON with higher rate in the future.

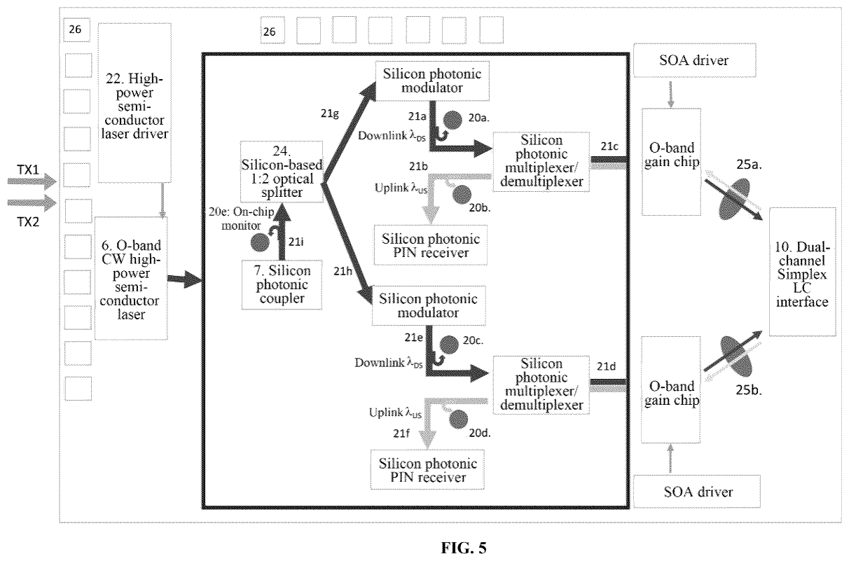

As shown in FIG. 5, when the driving electrical signals at the front end of the OLT are two paths of driving electrical signals, there is one O-band laser and driving component and two O-band gain chip and driving components. Such a mode of inputting through a single laser and outputting two paths refers to split one path of light source signal into two paths of independent optical signals on a silicon photonic chip in a 1:2 manner, and is used for the density-doubled 25G(S) PON, ITU-T50GPON, or a single path of 100GPON with higher rate in the future.

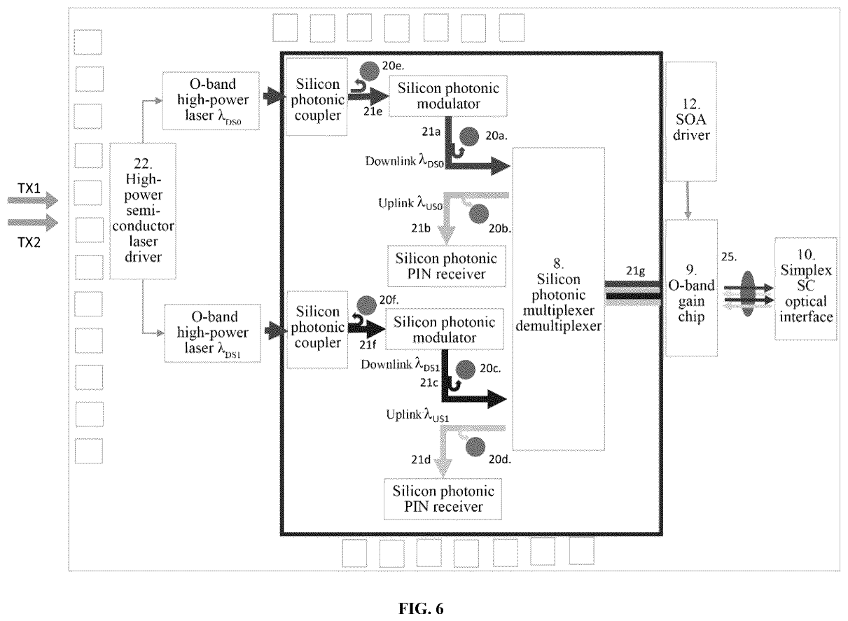

In the optical engine in FIG. 5, a high-power semiconductor laser can be configured to split a signal into two paths on the SiP chip by the silicon-based optical splitter 24, i.e., the silicon-based 1:2 optical splitter/1:2 optical splitter, thus achieving high-speed modulation, multiplexing/demultiplexing, transmitting and receiving of the signals on the chip. To illustrate the optical transmission process better, micro lenses 25a and 25b are shown in FIG. 5, which are configured to transmit the optical signal after gain processing to the optical interface. In FIG. 5 and FIG. 6, curved arrows are used to show the respective on-chip optical waveguides (i.e., corresponding on-chip waveguides in the optical signal transmission) and the respective optical monitors 20a to 20b in the process of uplink and downlink optical signal transmission, respectively, as shown by the solid circle.

As shown in FIG. 6, when the driving electrical signal at the front end of OLT are two paths of driving electrical signals, there are two O-band laser and driving components (e.g., in FIG. 6, a high-power semiconductor laser driver, a first O-band high-power laser for emitting λ_{DS0} laser wavelength, and a second O-band high-power laser for emitting λ_{DS1} laser wavelength), one O-band gain chip and driving component, and one micro lens 25. The optical interface of the optical engine in FIG. 6 is also configured to receive optical signals with two wavelengths, which are split into an uplink optical signal λ_{US0} and an uplink optical signal λ_{US1} after passing through the silicon photonic multiplexer/demultiplexer so as to enter respective silicon photonic PIN receivers.

It is particularly noted that the number of modulation driving signals of the optical engine shown in FIG. 6 is also two, as TX1 and TX2 shown in FIG. 6.

At the moment, the OLT optical transceiver to which the optical engine belongs can be used for an IEEE 50G-EPON system based on 2×25G. When the rates of the two paths of driving electrical signals are different, e.g., the rate of one path is 50 Gbps while the rate of another path is 25 Gbps, the 50GPON/25G Combo PON can be achieved. Further, the two electrical signals with different rates can be achieved with a single row of gold finger array of the SFP-DD/SFP-DD112 optical transceiver: each row is provided with a pair of 25 Gbps and 50 Gbps signals. The two electrical signals with different rates can also be achieved with two rows of gold finger arrays: two paths of 25 Gbps signals are provided on the first row of gold finger array, and two paths of 50 Gbps signals are provided on the second row of gold finger array. Furthermore, based on the combination of 2×25 Gbps and 2×50 Gbps electrical signals, and in conjunction with the silicon photonic integrated chip of FIG. 15 and FIG. 16, the Combo PON with two groups of 50G/25G can be achieved on one SFP-DD/SFP-DD112 optical transceiver.

The structure shown in FIG. 6 puts forward higher requirements for the integration of optoelectronic chip package. Compared with the single-channel optical engine shown in FIG. 4, an additional set of high-speed optoelectronic chips needs to be integrated, and the integration in the limited space of SFP is higher. While the integration of the structure shown in FIG. 15 and FIG. 16 is at least doubled compared with the integration shown in FIG. 6. In this embodiment, with the silicon-based optoelectronic integrated SiP technology, a variety of multi-grain (dozens to hundreds) silicon (germanium) devices, optocouplers, high-speed modulators, multiplexers and demultiplexers, optical interconnection waveguides, high-speed PIN receivers, 1:2 optical power splitters, on-chip optical power dynamic monitors, etc. can be integrated on a silicon chip with small area, which is suitable for the SFP-DD/SFP-DD112 miniaturized package facing the next generation of PON application with high performance, high density, and low power consumption.

When only the retimer function of the DSP or only the independent retimer chip is used, the optical transceiver may support Ethernet rate-based IEEE 802.3 ca 50G-EPON. The standard is configured to achieve 50G based on dual-wavelength 25G. In this case, the two paths have different wavelengths, and the downlink wavelengths are 1342 nm+2 nm and 1358 nm+2 nm, respectively. The lasers with different wavelengths are integrated to the optical engine, and the dual lasing wavelength enters the SiP chip through the silicon photonic coupler. The 1:2 optical splitter is not used in this embodiment, and the wavelengths at the receiving end are 1270 nm+/−10 nm and 1300+/−10 nm, respectively. The complexity of design, technology and packaging caused by the transmitting and receiving of different wavelengths can be effectively solved by silicon-based optoelectronic integrated chip. When the rates of two paths of electrical signals are inconsistent, the optical transceiver in this embodiment can be used for supporting Combo PON: when the rates of the two paths of electrical signals are 50 Gbps and 25 Gbps, respectively, the optical transceiver may support the future 50G/25G Combo PON. When the SerDes rate is upgraded to 28GBAUD (56G PAM4) or 56GBAUD (112G PAM4) rate, the optical transceiver of this embodiment may smoothly support the future single-port dual-wavelength 100G-EPON or 200G-EPON.

In other extended embodiments, when the driving electrical signals at the front end of OLT are two paths of driving electrical signals, there are two O-band laser and driving components, and two O-band gain chip and driving components, i.e., a dual-input and dual-output structure.

Certainly, when the driving electrical signals are four paths of driving electrical signals, there are two O-band laser and driving components, and two O-band gain chip and driving components, as shown in FIG. 15.

When the driving electrical signals are four paths of driving electrical signals, there are four O-band laser and driving components, and one O-band gain chip and driving component, as shown in FIG. 16.

The structures above may be adjusted according to actual needs.

It can be known from the structures shown from FIG. 4 to FIG. 6, the silicon photonic modulator 5 is configured to modulate a CW (Continuous Wave) laser signal entering the silicon photonic chip from the silicon photonic coupler at a high speed, and the high-speed modulated optical signal is sent to the silicon photonic multiplexer/demultiplexer 8 via the silicon photonic on-chip waveguide.

The O-band high-power semiconductor laser 6 is configured to output a transmitting end laser signal meeting the protocol wavelength requirement.

The silicon photonic coupler 7 is configured to couple the laser signal generated by the O-band high-power semiconductor laser to the transceiver integrated chip A1.

The silicon photonic multiplexer/demultiplexer 8, which is a dual filter (multiplexer/demultiplexer) on a silicon photonic integrated chip, is configured to couple transmitting signals from the silicon photonic modulator 5 and the electrical interface 2 into the O-wave gain chip 9.

The O-wave gain chip 9 is configured to amplify a transmitting (downlink λ_{DS}) O-band optical signal and a receiving (uplink λ_{US}) optical signal with different wavelengths simultaneously, where the downlink λ_{DS} is coupled to the Simplex LC optical interface 10 of the SPF-DD optical transceiver through a free space and a micro lens, and the uplink λ_{US} is coupled to the O-band gain chip 9 through the free space and the lens.

The Simplex LC optical interface 10 is provided; the downlink λ_{DS} is coupled into a transmission optical fiber via the Simplex LC optical interface and the uplink λ_{US} enters the transceiver via the Simplex LC optical interface, and then is coupled to the silicon photonic multiplexer/demultiplexer 8 through the free space and the lens (e.g., micro lens 25c).

The silicon photonic PIN receiver 11 is provided, and the downlink λ_{DS} enters this PIN receiver via an on-chip waveguide.

The SOA (Gain chip) driver 12 is configured to set an operating point of the O-band gain chip 9.

A micro TEC controller (not shown in figures) is configured to achieve micro temperature control and control the SiP temperature in a certain range, thus preventing the performance of the O-band high-power semiconductor laser from decreasing at high temperature and the performance of silicon photonic demultiplexer from drifting with temperature.

The high-power semiconductor laser driver 22 is configured to set the optimal operating point of the O-band high-power semiconductor laser.

The silicon photonic coupler, the silicon photonic multiplexer/demultiplexer, the silicon photonic modulator, the silicon photonic PIN receiver, the on-chip monitor and the on-chip waveguide supporting the PON application are silicon photonic monolithic integration of various functional devices achieved on a silicon-based material through one-time tape-out, which greatly improves the integration of high-speed optoelectronic chips and improves the reliability and production yield. However, O-band CW high-power semiconductor laser and O-band gain chip are optically coupled with SiP through heterogeneous integration.

When the downlink electrical signal is 25 Gbps, the downlink electrical signal forms a symmetrical single-channel 25G(S)PON operating mode with an uplink burst mode 25 Gbps, which may support a 25G(S) PON multi source agreement led by overseas equipment vendors (such as Nokia) and is suitable for the next generation of high-speed PON network of large overseas operators (AT&T, etc.). Through 2:1 gearbox (one of the functions of analog/digital signal processing integrated components), overseas equipment vendors and operators adopting 25G PON MAC can smoothly achieve PMD layer supporting 50G(S)PON without upgrading MAC and SerDes rates. When the downlink electrical signal is 50 Gbps, the downlink electrical signal forms a 50G(S) PON operating mode with the uplink 25 Gbps (or 50 Gbps), which supports the ITU-T 50GPON standard and the next generation of high-speed PON technical path selected by three major operators in China.

### Embodiment 3

It is provided a multi-rate central office module based on a silicon-based optoelectronic integrated chip. The central office module is a module employing an SFP-DD/SFP-DD112 package, and includes an electrical interface, an analog/digital signal processing integrated component with single/dual/four paths of rates, an optical engine, and a burst mode receiving and amplifying chipset.

The electrical interface is configured to achieve electrical signal transmission between the central office module and a system board.

The analog/digital signal processing integrated component is configured to perform clock data recovery, rate and/or pattern type conversion processing on a downlink electrical signal with a first parameter transmitted by the system board through the electrical interface, so as to obtain an electrical signal with a second parameter, which is used for being applied to an optical signal corresponding to the silicon-based optoelectronic integrated chip in the optical engine to achieve the modulation of the optical signal, and the modulated downlink optical signal is transmitted through the optical interface of the optical engine to a network end.

The uplink optical signal received by means of the optical interface of the optical engine is converted into an electrical signal by the receiving of the silicon-based optoelectronic integrated chip in the optical engine; and the electrical signal is transmitted via the burst mode receiving and amplifying chipset and the electrical interface to the system board.

The silicon-based optoelectronic integrated chip in the optical engine is a transceiver integrated chip for achieving the integration of the transmitting and receiving of optical signals.

In specific application, the silicon-based optoelectronic integrated chip in the optical engine of the central office module is any silicon-based optoelectronic transceiver integrated chip for the PON OLT system in embodiment 1. Certainly, the optical engine may be any optical engine for the PON OLT system in embodiment 2. The corresponding description of the optical engine refers to the description in embodiment 1 and embodiment 2, and will not be described here.

In addition, the SFP-DD of this embodiment achieves the higher challenge of the high-speed PON having a dual-channel Simplex LC optical interface (dual-channel BiDi) to the integration of photonic chips. Compared with the single-channel scenario, two or even four sets of optoelectronic chips supporting PON applications are required, but it is difficult to put all devices into the SFP-DD optical transceiver by using the conventional optical engine packaging method of hybrid integrated discrete devices. These functional devices and their interconnection can be achieved on a small chip by using the silicon-based optoelectronic integrated chip. For example, two sets of silicon photonic couplers, silicon photonic multiplexers/demultiplexers, silicon photonic modulators, silicon photonic PIN receivers, on-chip monitors and on-chip waveguides are needed, and silicon photonic splitters are added, through which monolithic integrated chip SiP can be achieved on the silicon-based materials through one-time tape-out.

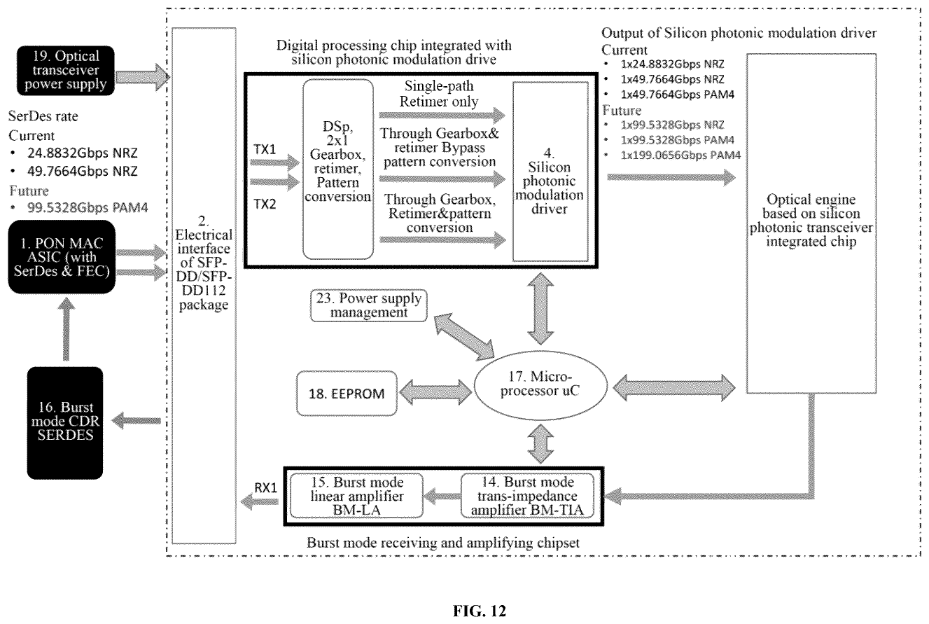

In addition, the electrical interface in the central office module of this embodiment may include: a gold finger array of a printed circuit board of the SFP-DD/SFP-DD112 package, i.e., an electrical interface 2 of the SFP-DD/SFP-DD112 package. The electrical interface of this embodiment is configured to achieve the connection between the 25/50/100/200G PON OLT system and/or the 50/100/200G EPON OLT system and the central office module, and the electrical interface includes one or more of the following interfaces: a single-path electrical interface, a dual-path electrical interface, and a four-path electrical interface. The PON MAC ASIC 1 in the system board shown in FIG. 12 enters the central office module via the electrical interface 2 of the SFP-DD/SFP-DD112 package, is processed by a digital processing chip 3 and a silicon photonic modulation driver 4, and then is output to the optical engine A2 so as to be output through the optical interface. Correspondingly, the uplink optical signal received by the optical interface is converted into an uplink electrical signal by the optical engine, is output to the burst mode CDR SERDES16 in the system board by means of the electrical interface 2 after passing through the burst mode trans-impedance amplifier BM-TIA 14 and the burst mode linear amplifier BM-LA 15, then enters the PON MAC ASIC 1.

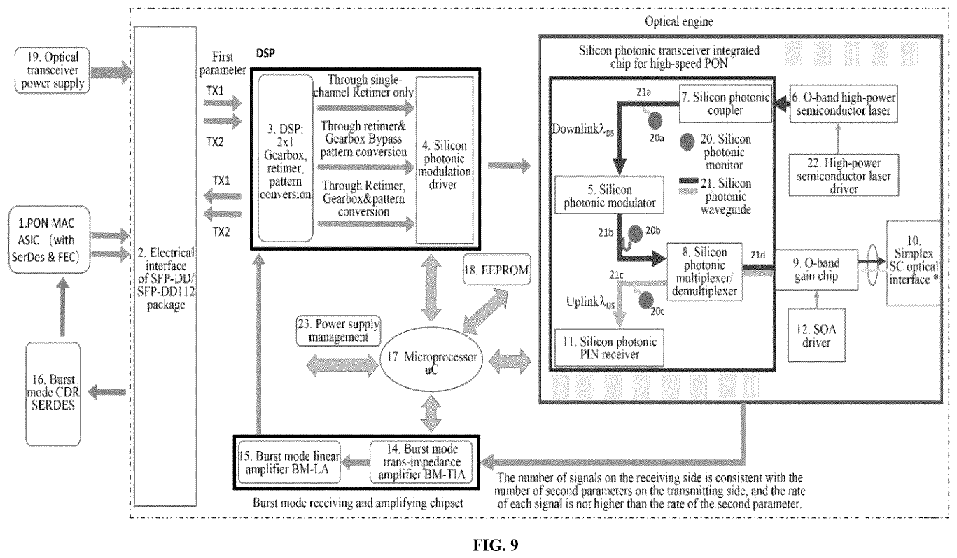

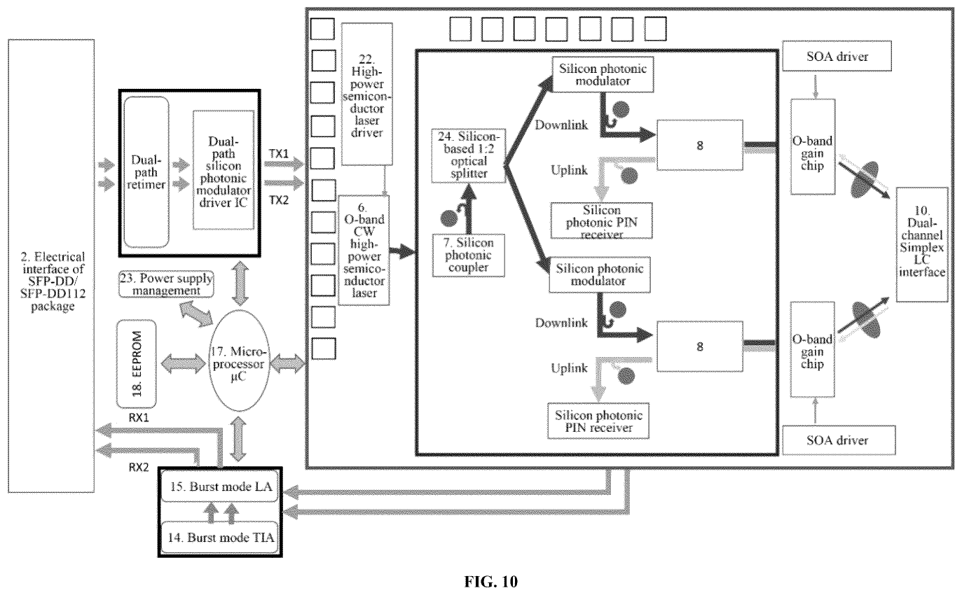

Referring to FIG. 9 and FIG. 10, an analog/digital signal processing integrated component includes a digital process chip DSP 3, and a modulation driving component for optical signal modulation.

The DSP 3 is configured to perform clock data recovery, rate and/or pattern mapping conversion on a single path of electrical signal or two paths of electrical signals (e.g., TX1 and TX2) transmitted by the electrical interface according to parameters of optical transmission equipment, so as to obtain one path of downlink electrical signal which is consistent with the parameter of the optical transmission equipment, and one path of driving electrical signal is obtained through the modulation driving component.

Specifically, the DSP includes a Retimer component, a Gearbox component, and a pattern conversion module.

When single path like 1×25 Gbps or 1×50 Gbps NRZ or 1×100 Gbps PAM4 pattern is input, the Gearbox component of the DSP does not operate, and the single-path Retimer component is configured to perform clock data recovery on the single path of input electrical signal, and to output a single path like 1×25 Gbps NRZ or 1×50 Gbps NRZ or 1×100 Gbps PAM4 pattern, so as to serve as a downlink electrical signal.

When two paths like 2×25 Gbps NRZ patterns are input, the Retimer component and the Gearbox component are configured to map and convert the two paths of input electrical signals 2×25 Gbps NRZ into a single path of 50 Gbps NRZ pattern, so as to serve as one path of output downlink electrical signal.

When two paths like 2×25 Gbps NRZ patterns are input, the Retimer component, the Gearbox component and the pattern conversion module are configured to map and convert two paths of input signals 2×25 Gbps NRZ into a single path of 50 Gbps PAM4 pattern, so as to serve as one path of output downlink electrical signal.

When two paths like 2×50 Gbps NRZ patterns are input, the Retimer component and the Gearbox component are configured to map and convert two paths of input signals 2×50 Gbps NRZ into a single path of 100 Gbps NRZ pattern, so as to serve as one path of output downlink electrical signal.

When two paths like 2×50 Gbps NRZ patterns are input, the Retimer component, the Gearbox component and the pattern conversion module are configured to map and convert two paths of input signals 2×50 Gbps NRZ into a single path of 100 Gbps PAM4 pattern, so as to serve as one path of output downlink electrical signal.

When two paths like 2×100 Gbps PAM4 patterns are input, the Retimer component and the Gearbox component are configured to map and convert two paths of input signals 2×100 Gbps PAM4 into a single path like 1×200 Gbps PAM4 pattern, so as to serve as one path of output downlink electrical signal.

When the rate of a first parameter electrical signal is not higher than 25 Gpbs, high-quality transmission and receiving of a high-speed electrical signal between the optical component and the system board can be achieved using the retimer. When the rate of the first parameter electrical signal is not less than 50 Gbps, the DSP chip is required to process the high-speed electrical signal, and the retime-only is only used in some scenarios with limited transmission performance. The case of OLT optical module shown in FIG. 9 through FIG. 14 covers three types of functional architecture: the DSP is configured to process transmitting and receiving signals, the retimer-only is configured for transmission and receiving, and the DSP is only configured to process a transmitting end signal, and the receiving end does not require the DSP.

Referring to FIG. 10, an analog/digital signal processing integrated component in this embodiment includes a dual-path retimer component, and a modulation driving component for optical signal modulation.

The dual-channel retimer component is configured to perform clock data recovery, rate and/or pattern mapping conversion on two paths of electrical signals transmitted by the electrical interface according to the parameters of optical transmission equipment, so as to obtain two paths of downlink electrical signals which are consistent with the parameters of the optical transmission equipment, and two paths of driving electrical signals are obtained through the modulation driving component.

The dual-channel retimer component may include: a retimer chip.

When two paths like 2×25 Gbps NRZ patterns are input, the retimer chip is configured to perform clock data recovery on the two paths of electrical signals received by the electrical interface and to map and convert the electrical signals into two paths of 25 Gbps NRZ patterns, so as to serve as two paths of output downlink electrical signals.

When two paths like 2×50 Gbps NRZ patterns are input, the retimer chip is configured to perform clock data recovery on two paths of electrical signals received by the electrical interface and to map and convert the electrical signals into two paths like 2×50 Gbps NRZ patterns, so as to serve as two paths of output downlink electrical signals.

When the two paths of rates are input in combination, one of which is 25 GbpsNRZ pattern while the other is 50 Gbps NRZ pattern, the retimer is configured to perform clock data recovery on two paths of electrical signals received by the electrical interface and to map and convert the electrical signals into one path of 25 GbpsNRZ pattern and one path of 50 Gbps NRZ pattern, so as to serve as two paths of output downlink electrical signals.

When two paths like 2×100 Gbps PAM4 patterns are input, the retimer or the DSP chip is configured to perform clock data recovery on two paths of electrical signals received by the electrical interface and to map and convert the electrical signals into two paths like 2×100 Gbps PAM4 patterns, so as to serve as two paths of output downlink electrical signals.

It needs to be noted that when only the retimer function is used, both the dual-channel Bi-directional optical interface mode and the dual-channel 25G(S) PON or 50G(S) PON can be supported. The advantage of the dual-channel PON transceiver is to support the OLT system with higher density and higher performance. On the premise of unchanging the PON MAC serdes rate, the total bandwidth of PON connection is doubled compared with a single-channel scenario. One PON board, which can support 16-port SFP+PON OLT optical transceiver in the past, now can support thirty-two high-speed PON ports.

In other embodiments, the analog/digital signal processing integrated component includes a four-path DSP (containing retimer) or an independent retimer component, and a modulation driving component for optical signal modulation. At the moment, the four-path retimer component is configured to perform clock data recovery, rate and/or pattern mapping conversion on four paths of electrical signals transmitted by the electrical interface according to the parameters of optical transmission equipment, so as to obtain four paths of downlink electrical signals which are consistent with the parameters of the optical transmission equipment, and four paths of driving electrical signals are obtained through the modulation driving component. The four paths of signals may be consistent in rate, for example, the four paths of signals all employ the rate of 4×25 Gbps and 4×50 Gbps; or the rates of the four paths of signals may be consistent in pairwise, for example, the combination of 2×25 Gbps+2×50 Gbps.

Specifically, the four-path retimer component includes a retimer chip.

When four paths like 4×25 Gbps NRZ patterns are input, the retimer chip is configured to perform clock data recovery on four paths of electrical signals received by the electrical interface and to map and convert the electrical signals into four paths of 25 Gbps NRZ patterns, so as to serve as four paths of output downlink electrical signals.

When four paths like 4×50 Gbps NRZ patterns are input, the retimer chip is configured to perform clock data recovery on four paths of electrical signals received by the electrical interface and to map and convert the electrical signals into four paths like 4×50 Gbps NRZ patterns, so as to serve as four paths of output downlink electrical signals.

When four paths like 2×25 Gbps and 2×50 Gbps are input in combination, the retimer or DSP chip is configured to perform clock data recovery on four paths of electrical signals received by the electrical interface and to map and convert the electrical signals into four paths like 2×25 Gbps and 2×50 Gbps NRZ patterns, so as to serve as four paths of output downlink electrical signals.

In actual application, the modulation driving component is a silicon photonic modulation driving component, and is integrated into the DSP, or is integrated on a component with the retimer chip.

In addition, the burst mode receiving and amplifying chipset in the central office module of the embodiment may include: a burst mode receiving trans-impedance amplifier 14, and a burst mode receiving linear amplifier 15, referring to FIG. 9 through FIG. 11.

The DSP is configured to perform clock data recovery, rate and/or pattern mapping conversion on a single path of electrical signal or two paths of electrical signals, i.e., the first parameter, transmitted by the electrical interface according to the parameters of optical transmission equipment, so as to obtain one path of downlink electrical signal meeting transmission parameter requirements of the optical transmission equipment, and one path of driving electrical signal, i.e., the second parameter, is obtained through the modulation driving component.

It may be understood that when the electrical signal with the second parameter is one path of electrical signal, there is one path of input-output burst mode electrical signal of the burst mode receiving and amplifying chipset, as shown in FIG. 9; and the rate of the electrical signal of the burst mode receiving and amplifying chipset is equal to or lower than that of the electrical signal with the second parameter.

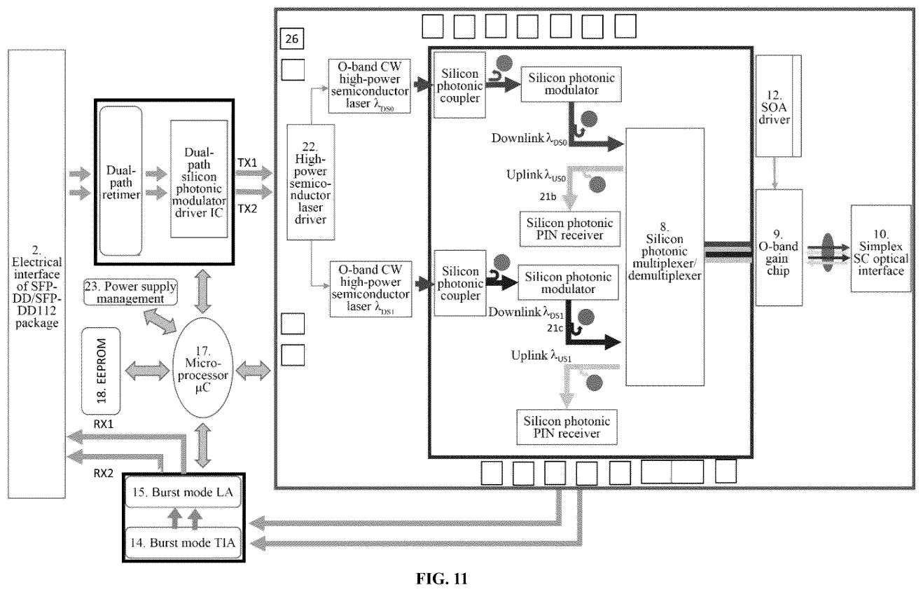

When the electrical signals with the second parameter are two paths of electrical signals, there are two paths of input-output burst mode electrical signals of the burst mode receiving and amplifying chipset, as shown in FIG. 10 and FIG. 11; and the rates of the two electrical signals of the burst mode receiving and amplifying chipset are not higher than that of the electrical signal with the second parameter.

When the electrical signals with the second parameter are four paths of electrical signals, there are four paths of input-output burst mode electrical signals of the burst mode receiving and amplifying chipset, and the rates of the four electrical signals of the burst mode receiving and amplifying chipset are not higher than that of the electrical signal with the second parameter.

The second parameter may also be:
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain a single path of downlink electrical signal meeting transmission parameter requirements of the optical transmission equipment, and a single path of driving electrical signal, i.e., the second parameter, is obtained through the modulation driving component;
or the digital processing chip DSP and a modulation driving component for the modulation of a silicon photonic signal;
the DSP is configured to perform clock data recovery, rate and/or pattern mapping conversion on four paths of electrical signals transmitted by the electrical interface according to the parameters of optical transmission equipment, so as to obtain two paths of downlink electrical signals meeting transmission parameter requirements of the optical transmission equipment, and two paths of driving electrical signals, i.e., the second parameter, are obtained through the modulation driving component; or the digital processing chip DSP and a modulation driving component for the modulation of a silicon photonic signal;
the DSP is configured to perform clock data recovery, rate and/or pattern mapping conversion on four paths of electrical signals transmitted by the electrical interface according to the parameters of optical transmission equipment, so as to obtain four paths of downlink electrical signals meeting transmission parameter requirements of the optical transmission equipment, and four paths of driving electrical signals, i.e., the second parameter, are obtained through the modulation driving component.

Specifically, when the downlink electrical signal output by the DSP or retimer is a single path like 1×25 Gbps NRZ, an uplink electrical signal passing through the burst mode receiving and amplifying chipset is a single path like 1×25 Gbps NRZ;
when the downlink electrical signal output by the DSP is a single path like 1×50 Gbps NRZ, an uplink electrical signal passing through the burst mode receiving and amplifying chipset is a single path like 1×25 Gbps NRZ or 1×50 Gbps NRZ;
when the downlink electrical signal output by the DSP is a single path like 1×100 Gbps NRZ, an uplink electrical signal passing through the burst mode receiving and amplifying chipset is a single path like 1×50 Gbps NRZ, 1×100 Gbps NRZ or single path like 1×100 Gbps PAM4;
when the downlink electrical signal output by the DSP is a single path like 1×50 Gbps PAM4, an uplink electrical signal passing through the burst mode receiving and amplifying chipset is a single path like 1×50 Gbps PAM4 or a single path like 1×25 Gbps NRZ;
when the downlink electrical signal output by the DSP is a single path like 1×100 Gbps PAM4, an uplink electrical signal passing through the burst mode receiving and amplifying chipset is a single path like 1×100 Gbps PAM4 or a single path like 1×50 Gbps NRZ; and
when the downlink electrical signal output by the DSP or is a single path like 1×200 Gbps PAM4, an uplink electrical signal passing through the burst mode receiving and amplifying chipset is a single path like 1×200 Gbps PAM4 or a single path like 1×100 Gbps PAM4.

When the downlink electrical signals output by the retimer chip are two paths like 2×25 Gbps NRZ, uplink electrical signals passing through the burst mode receiving and amplifying chipset are two paths like 2×25 Gbps NRZ;
when the downlink electrical signals output by the retimer or DSP chip are two paths like 2×50 Gbps NRZ, uplink electrical signals passing through the burst mode receiving and amplifying chipset are two paths like 2×50 Gbps NRZ, or two paths like 2×25 Gbps NRZ, or the combination of a single path like 1×50 Gbps NRZ and a single path like 1×25 Gbps NRZ; and
when the downlink electrical signals output by the retimer or DSP chip are two paths like 2×100 Gbps PAM4, uplink electrical signals passing through the burst mode receiving and amplifying chipset are two paths like 2×100 Gbps PAM4 or two paths like 2×50 Gbps NRZ.

When the downlink electrical signal output by the retimer or DSP chip is the combination of a single path like 1×25 Gbps NRZ and a single path like 1×50 Gbps NRZ, the uplink electrical signal passing through the burst mode receiving and amplifying chipset is the combination of a single path like 1×25 Gbps NRZ or a single path like 1×50 Gbps NRZ, or two paths like 2×25 Gbps NRZ;
when the downlink electrical signals output by the retimer or DSP chip are four paths like 4×25 Gbps NRZ, the uplink electrical signals passing through the burst mode receiving and amplifying chipset are four paths like 4×25 Gbps NRZ;
when the downlink electrical signals output by the retimer or DSP chip are four paths like 4×50 Gbps NRZ, the uplink electrical signals passing through the burst mode receiving and amplifying chipset are four paths like 4×50 Gbps NRZ; and
when the downlink electrical signal output by the retimer or DSP chip is the combination of four paths like 2×25 Gbps NRZ and 2×50 Gbps NRZ, an uplink electrical signal passing through the burst mode receiving and amplifying chipset is the combination of four paths like 2×25 Gbps NRZ or 2×50 Gbps NRZ, or the four paths like 4×25 Gbps NRZ.

In other embodiments, the central office module is also required to include a microprocessor 17, an EEPROM 18, and a power supply management component 23. The processing mode for these components may be consistent with the processing mode for each component in the existing central office module, and will not be described in detail in this embodiment. In addition, an optical transceiver power supply 19 for providing power for the central office module is also shown in FIG. 12, and can be configured as required in actual application.

The central office equipment used in the embodiment employs a miniaturized SFP-DD/SFP-DD112 module, thus effectively achieving the port high-density and high-performance demands of the next generation of OLT system equipment.

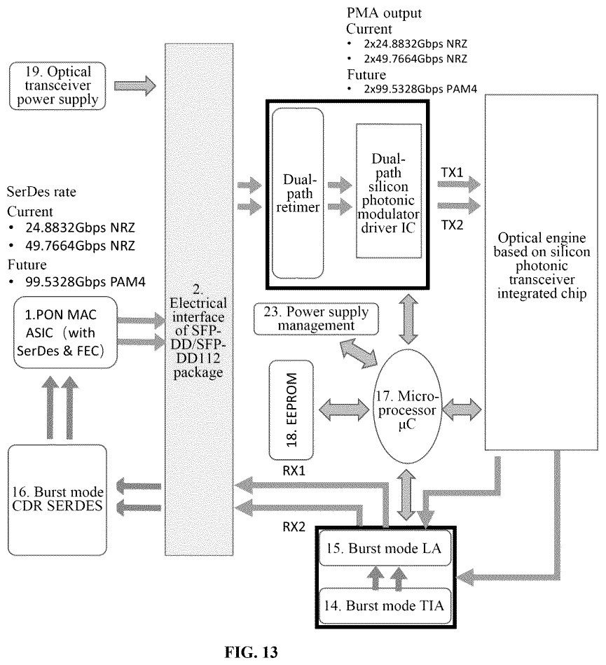

It can be known from the FIG. 12 through FIG. 14, the applicable SerDes rate applicable in FIG. 12 and FIG. 13 are 24.8832 Gbps NRZ and 49.7664 Gbps NRZ at present, and the future SerDes rate may be up to 99.5328 Gbps PAM4. Specifically, the left side in FIG. 12 through FIG. 14 belongs to the OLT PON MAC in the system board, which is located on the system board, and the physical coding sublayer (PCS) function, including forward error correction (FEC), signal encoding/decoding and the like, can be achieved in an ASIC (Application Specific Integrated Circuit) or a FPGA (Field Programmable Gate Array) manner. The single path of high-speed signal of the MAC uses ITU-T PON standard rate 24.8832 Gbps (25 Gbps for short) or 49.7664 Gbps (50 Gbps), with an encoding mode of NRA, the function of the structure is consistent with that of the existing structure, and will not be described in detail here. The single path of high-speed signal of the MAC may also be increased to 99.5328 Gbps in the future, with an encoding mode of PAM4. The single path of high-speed signal of the MAC may also use the Ethernet rate 25.78125 Gbps (25 Gbps for short).

It needs to be noted that in FIG. 13, the PMA can output 2*24.8832 Gbps NRZ and 2*49.7664 Gbps NRZ at present, and can output 2*99.5328 Gbps PAM4 in the future.

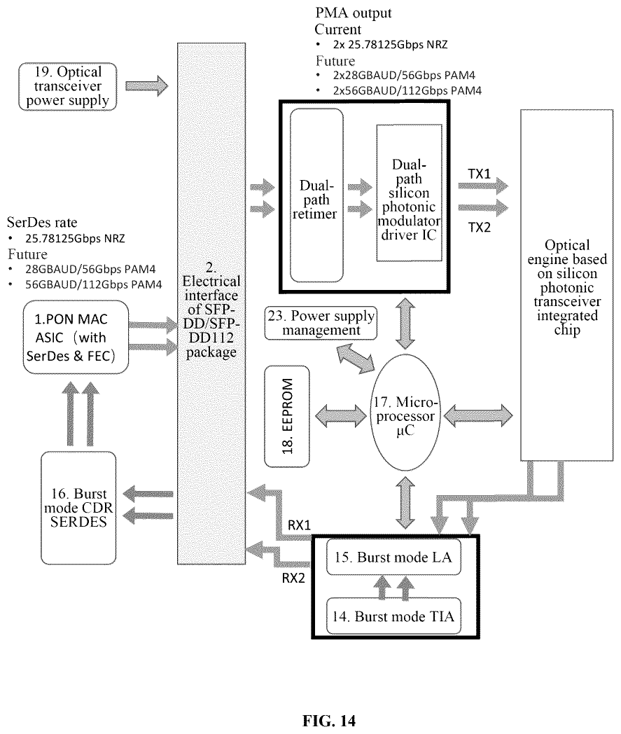

In FIG. 14, the SerDes single path rate is 28G NRZ at present, and the single path rate of the optical port is 25.78125 Gbps NRZ at present. In the future, the SerDes single path rate of the Ethernet PON may be up to 56 Gbps PAM4 and 112 Gbps PAM4.

The electrical interface is provided, high-speed signals, control signals and power supply of the system board enter or exit the optical transceiver through the electrical interface; the electrical interface may provide two paths of high-speed electrical inputs (TX1&2) and outputs (RX1&2) at the same time, or may only provide one path of input-output (Tx1+Rx1) according to the requirements of the system board.

The silicon photonic modulator driver/silicon photonic modulation driving component is provided, the high-speed signals after mapping and conversion are superposed on such a driver, and the driver is configured for the high-speed modulation of the silicon photonic modulator. The current output of the silicon photonic modulation driver shown in FIG. 12 is 1*24.8832 Gbps NRZ, 1*49.7664 Gbps NRZ, 1*49.7664 Gbps PAM4, and the output of the future silicon photonic modulation driver may be 1*99.5328 Gbps NRZ, 1*99.5328 Gbps PAM4, 1*199.0656 Gbps PAM4.

The burst mode trans-impedance amplifier 14 is configured to amplify a 25G or 50G burst mode signal received by the PIN receiver 11.

The burst mode linear amplifier 15 is configured to amplify a 25G/50G differential electrical signal output by the burst TIA, thus reducing the loss of preambles.

BM CDR SERDES(burst mode clock data recovery Serdes) is located on the system board. The receiving signal Rx1 enters the BM CDR SERDES 16 after passing through the burst mode linear amplifier 15 and the electrical interface 2. Under the reference of the local accurate clock signal of 24.8832 Gbps or 49.7664 Gbps, the signal of the burst limiting amplifier is subjected to frequency and phase discrimination processing to eliminate the jitter and intersymbol interference of the uplink signal and then is transmitted back to the PON MAC ASIC 1 in the system.

The microprocessor 17 is configured to process control signals and sensing signals of various devices of the optical transceiver and coordinate the operation of various devices.

The EEPROM (Electrically Erasable Programmable Read-only Memory) 18 is configured to store performance and control information of various optical devices inside the optical transceivers; and when the optical transceiver operates normally, the micro TEC controller is configured to call corresponding technical parameters in the EEPROM 18 through I²C.

The optical transceiver power supply 19 is configured to provide the power required for normal operation of each component of the optical transceiver through the electrical interface 2, for example, a 3.3V power input may be provided.

The power supply management component 23 is configured to buck or boost the 3.3 V total power of the optical transceiver to the level required by each unit circuit, and to supply power to the corresponding unit circuit according to the specified time sequence.

In this embodiment, the electrical interface defined by using the SFF-DD MSA protocol combined with ITU-T PON rate definition also provides a direct path for upgrading the optical port rate to a single path of 100GPON in the same package, and the NRZ or PAM4 may be flexibly used for the encoding mode.

In addition, the SFP-DD112 MSA has increased the support for single path of 100G PAM4 input signal, so the above optical transceiver can be extended to a single path of 200GPON (an output signal after 2×1 gearbox) in the future on the SFP-DD112 package.

### Embodiment 4

The embodiment further provides a passive optical network PON OLT system, which includes any multi-rate-channel central office module based on the silicon-based optoelectronic integrated chip in the embodiment 4, and the system interacts with a PON network side through the central office module. Basic hardware units of the system include a power supply, a shelf, and a board. In this embodiment, the number of SFP-DD/SFP-DD112 optical transceivers capable of being plugged into the office board of the PON OLT system is sixteen.

It can be known from FIG. 1 to FIG. 16, an encoded high-speed signal transmitted by the PON MAC ASIC 1 enters a digital processing chip (DSP) 3 in the optical transceiver via an electrical interface 2 of the SFP-DD/SFP-DD112 package. The signal rate follows the ITU-T PON standard rate requirements: 24.8832 Gbps (25 Gbps for short) or 49.7664 Gbps (50 Gbps), with the encoding mode of NRZ. The SFP-DD/SFP-DD112 may support two paths of high-speed electrical signal inputs (TX1&TX2) and outputs (RX1&RX2), or may only employ one path of input-output (Tx1+Rx1).

The single/dual/four paths of high-speed signals output by the digital processing chip (DSP) 3 is applied to a silicon photonic modulation driver 4, the silicon photonic modulation driver 4 is configured for high-speed modulation, a high-power semiconductor laser driver 22 is configured to set the optimal operating point of a O-band high-power semiconductor laser 6, and the O-band high-power semiconductor laser 6 with the optimal operating point is configured to output a high-power laser signal to serve as a PON downlink light source. According to the requirements of the ITU-T 50GPON, IEEE 25G/50G-EPON and 25G(S) PON, the lasing wavelength in the whole working temperature range is maintained at 1342 nm+/−2 nm and 1358 nm+/−2 nm.

The 1342 nm+/−2 nm and 1358 nm+/−2 nm enter the transceiver integrated chip A1 through the silicon photonic coupler 7, enter the silicon photonic modulator 4 for high-speed modulation through the on-chip waveguide, then leave the transceiver integrated chip A1 after passing a silicon photonic multiplexer/demultiplexer via the on-chip waveguide, and then are couple into the O-band gain chip 9. The optimal chip operation point of the O-band gain chip 9 is set by the SOA driver 12, and the transmitting (downlink λ_{DS}) and receiving (uplink λ_{US}) O-band optical signals with different wavelengths are simultaneously amplified by this gain chip.

The λ_{DS} transmitting high-power signal amplified by the O-band gain chip 9 is coupled to a Simplex SC optical interface 10 of the SFP-DD/SFP-DD112 optical transceiver via a micro lens (25c, 25a, or 25b), and then enters the far end of an optical fiber transmission network.

The signal in a receiving direction is described as follows:

The uplink λ_{US} enters an optical engine of the optical transceiver from the transmission optical fiber via the Simplex SC optical interface 10.

The uplink λ_{US} enters the O-band gain chip 9 for amplification via the micro lens (25c, 25a, or 25b), and then passes through the silicon optical multiplexer/demultiplexer; the uplink λ_{US} enters the silicon optical PIN receiver 11 through the silicon photonic multiplexer/demultiplexer 8; the silicon photonic PIN receiver 11 is configured to convert a single path of high-speed uplink burst mode λ_{US} optical signal into a single path of burst mode high-speed electrical signal. The burst mode high-speed electrical signal output by the silicon photonic PIN receiver 11, after passing through the burst mode trans-impedance amplifier 14, the burst mode linear amplifier 15, and the electrical interface 2 of the SFP-DD/SFP-DD112 package in sequence, leaves the optical transceiver to enter the system board; and the signal, after passing through the BM CDR SERDES 16 of the high-speed system board, enters the PON MAC ASIC 1 to complete the closed loop of the signal transmitting and receiving on the OLT side.

It should be noted that any reference numerals located between the brackets in the claims should not be construed as limiting the claims. The word “including/comprising” does not exclude the presence of elements or steps not listed in the claims. The word “a” or “an” in front of element does not exclude the presence of a plurality of such elements. The above embodiments can be achieved by means of hardware including a number of different elements and by means of a suitably programmed computer. In the claim listing a plurality of devices, some of these devices may be embodied in the same hardware. The use of the words such as first, second, and third are merely for convenience of expression rather than indicating any order. These words may be construed as a part of the element name.

In addition, it should be noted that in the description of this specification, the description made with reference to terms “an embodiment”, “some embodiments”, “embodiments”, “example”, “specific examples”, or “some examples” means that the specific features, structures, materials or characteristics described in connection with this embodiment or example are included in at least one embodiment or example. In this specification, the schematic representations of the above terms are not necessarily directed to the same embodiment or example. Furthermore, the specific features, structures, materials, or characteristics described may be combined in any one or more embodiments or examples in a suitable manner. In addition, those skilled in the art may combine the different embodiments or examples and the features of the different embodiments or examples described in this specification without contradicting each other.

Although the technical solution of each embodiment has been described, those skilled in the art may make other changes and modifications to these embodiments after learning the basic creative concepts. Therefore, the claims should be construed to include alternative embodiments as well as all changes and modifications falling within the scope of the present disclosure.

Apparently, those skilled in the art can make various modifications and variations to the present disclosure without departing from the spirit and scope of the present disclosure. Therefore, in a case that these modifications and variations of the present disclosure are within the scope of the claims and their equivalents, the present disclosure should also include these modifications and variations.

1. A silicon-based optoelectronic transceiver integrated chip for a PON OLT system, wherein the transceiver integrated chip is located in the optical engine of an OLT and is an integrated chip for achieving the integration of transmitting and receiving, and the transceiver integrated chip is configured to modulate an optical signal based on a single path/two paths/or four paths of driving electrical signals at the front end of the OLT, and the modulated downlink optical signal is subjected to gain processing of the optical engine and then is transmitted via an optical interface of the optical engine; and
the transceiver integrated chip is configured to perform photoelectric conversion on an uplink optical signal received by the optical interface of the optical engine and then to transmit the photoelectrically converted uplink optical signal to a burst mode receiving and amplifying chipset of the OLT located on an external region of the optical engine for processing.

2. The silicon-based optoelectronic transceiver integrated chip according to claim 1, wherein
in a case that the driving electrical signal is one path of driving electrical signal, the modulated downlink optical signal is one path of downlink optical signal;
in a case that the driving electrical signals are two paths of independent driving electrical signals, the transceiver integrated chip is configured to modulate an optical signal based on each path of driving electrical signal, and the modulated downlink optical signals are two paths of downlink optical signals;
in a case that the driving electrical signals are four paths of independent driving electrical signals, the transceiver integrated chip is configured to modulate an optical signal based on each path of driving electrical signal, and the modulated downlink optical signals are four paths of downlink optical signals;
in a case that the uplink optical signal received by the optical interface is one path of uplink optical signal, the transceiver integrated chip is configured to perform photoelectric conversion on the path of uplink optical signal and to output one path of converted electrical signal;
in a case that the uplink optical signals received by the optical interface are two paths of uplink optical signals, the transceiver integrated chip is configured to perform photoelectric conversion on the two paths of uplink optical signals and to output two paths of converted independent electrical signals; and
in a case that the uplink optical signals received by the optical interface are four paths of uplink optical signals, the transceiver integrated chip is configured to perform photoelectric conversion on the four paths of uplink optical signals and to output four paths of converted independent electrical signals.

3. The silicon-based optoelectronic transceiver integrated chip according to claim 1, wherein when the driving electrical signal is one path of driving electrical signal, the transceiver integrated chip comprises:
a silicon photonic coupler, a silicon n photonic modulator, a silicon photonic multiplexer/demultiplexer, and a silicon photonic PIN receiver;
the silicon photonic coupler is configured to receive a laser signal which is transmitted from a laser component in the optical engine and serves as a downlink light source, the downlink light source is transmitted via an optical path into the silicon photonic modulator for modulation, and the silicon photonic modulator is configured to modulate the downlink light source based on the driving electrical signal, so as to obtain a modulated optical signal;
the modulated optical signal is transmitted to the silicon photonic multiplexer/demultiplexer through the optical path, and then is output to the optical engine, thus enabling the optical engine to perform gain processing on the optical signal and perform downlink transmission via the optical interface; and
the uplink optical signal received by the optical interface is subjected to gain amplification in the optical engine and then enters the silicon photonic PIN receiver via the silicon photonic multiplexer/demultiplexer for photoelectrical conversion for output.

4. The silicon-based optoelectronic transceiver integrated chip according to claim 1, wherein when the driving electrical signal are two paths of driving electrical signals, the transceiver integrated chip comprises:
a silicon photonic coupler, a silicon-based optical splitter, two silicon photonic modulators, two silicon photonic multiplexers/demultiplexers, and two silicon photonic PIN receivers;
the silicon photonic coupler is configured to receive a laser signal which is transmitted from a laser component in the optical engine and serves as a downlink light source, and the downlink light source is subjected to optical splitting processing by the silicon-based optical splitter to form two paths of downlink light sources;
each path of downlink light source is transmitted via the optical path into the respective corresponding silicon photonic modulator for modulation, and each silicon photonic modulator is configured to modulate the path of downlink light source based on one path of driving electrical signal, so as to obtain one path of modulated optical signal;
the two paths of modulated optical signals are transmitted via optical paths to the respective silicon photonic multiplexers/demultiplexers and then are output to the optical engine, respectively, thus enabling two gain components of the optical engine to perform gain processing on two paths of outputs and perform downlink transmission of the two paths of optical signals via the optical interface; and
the two paths of uplink optical signals received via the optical interface, after being subjected to gain amplification respectively in the two gain components of the optical engine, enter the respective silicon photonic multiplexers/demultiplexers for processing, and then are transmitted via the optical paths to the respective silicon photonic PIN receivers for photoelectric conversion; and each silicon photonic PIN receiver is configured to output one path of converted electrical signal.

5. The silicon-based optoelectronic transceiver integrated chip according to claim 1, wherein when the driving electrical signals are two paths of driving electrical signals, the transceiver integrated chip comprises:
two silicon photonic couplers, two silicon photonic modulators, a silicon photonic multiplexer/demultiplexer, and two silicon photonic PIN receivers;
each silicon photonic coupler is configured to receive a laser signal which is transmitted from a corresponding laser component in the optical engine and serves as a downlink light source, laser signals respectively corresponding to the two paths of downlink light sources have different wavelengths, the downlink light sources are transmitted via optical paths into the respective corresponding silicon photonic modulators for modulation, and each silicon photonic modulator is configured to modulate the path of downlink light source based on one path of driving electrical signal, so as to obtain one path of modulated optical signal;
the two paths of modulated optical signals are transmitted via the optical paths to one silicon photonic multiplexer/demultiplexer so as to output two paths of downlink optical signals to the optical engine, thus enabling a gain component of the optical engine to perform gain processing on the two paths of outputs and perform downlink transmission of the two paths of optical signals via the optical interface; and
the two paths of uplink optical signals received via the optical interface, after being subjected to gain amplification in the gain component of the optical engine, are processed by the silicon photonic multiplexer/demultiplexer into two paths of uplink optical signals, each path of uplink optical signal is transmitted via the optical path to the respective silicon photonic PIN receiver for photoelectric conversion, and each silicon photonic PIN receiver is configured to output one path of converted electrical signal.

6. The silicon-based optoelectronic transceiver integrated chip according to claim 1, wherein when the driving electrical signals are four paths of driving electrical signals, the transceiver integrated chip comprises:
two silicon photonic couplers, two silicon-based optical splitters, four silicon photonic modulators, two silicon photonic multiplexers/demultiplexers, and four silicon photonic PIN receivers;
the two silicon photonic couplers are configured to respectively receive laser signals which are transmitted from two laser components in the optical engine and serve as downlink light sources, the two laser signals have different wavelengths, and the downlink light sources are subjected to optical splitting processing via the silicon-based optical splitters to form four paths of downlink light sources, wavelengths of which are consistent in pairwise;
each path of downlink light source is transmitted via an optical path into the respective corresponding silicon photonic modulator for modulation, and each silicon photonic modulator is configured to modulate the path of downlink light source based on one path of driving electrical signal, so as to obtain one path of modulated optical signal;
the four paths of modulated optical signals are respectively transmitted via the optical paths to the silicon photonic multiplexers/demultiplexers, two optical signals having different wavelength form a group, and a total of two groups is respectively output to the optical engine through the two silicon photonic multiplexers/demultiplexers, thus enabling two gain components of the optical engine to perform gain processing on the outputs of four paths of optical signals in two groups and perform downlink transmission of the four paths of optical signals via the optical interface; and
the four paths of uplink optical signals received via the optical interface, after being subjected to gain amplification respectively in the two gain components of the optical engine, enter the respective silicon photonic multiplexers/demultiplexers for processing, and then are transmitted via the optical paths to the respective silicon photonic PIN receivers for photoelectric conversion, and each silicon photonic PIN receiver is configured to output one path of converted electrical signal.

7. The silicon-based optoelectronic transceiver integrated chip according to claim 1, wherein when the driving electrical signals are four paths of driving electrical signals, the transceiver integrated chip comprises:
four silicon photonic couplers, four silicon photonic modulators, one silicon photonic multiplexer/demultiplexer, and four silicon photonic PIN receivers;
each silicon photonic coupler is configured to receive a laser signal which is transmitted from a corresponding laser component in the optical engine and serves as a downlink light source, the four paths of laser signals have different wavelengths, the downlink light sources are transmitted via optical paths into the respective corresponding silicon photonic modulators for modulation, and each silicon photonic modulator is configured to modulate the path of downlink light source based on one path driving electrical signal, so as to obtain one path of modulated optical signal;
the four paths of modulated optical signals are transmitted via the optical paths to one silicon photonic multiplexer/demultiplexer so as to output four paths of downlink optical signals to the optical engine, thus enabling one gain component of the optical engine to perform gain processing on four paths of outputs and perform downlink transmission of the four paths of optical signals via the optical interface; and
the four paths of uplink optical signals received via the optical interface, after being subjected to gain amplification in one gain component of the optical engine, are processed by one silicon photonic multiplexer/demultiplexer into four paths of uplink optical signals, each path of uplink optical signal is transmitted via the optical path to the respective silicon photonic PIN receiver for photoelectric conversion, and each silicon photonic PIN receiver is configured to output one path of converted electrical signal.

8. The silicon-based optoelectronic transceiver integrated chip according to claim 1, wherein the transceiver integrated chip further comprises a silicon photonic waveguide and a silicon photonic monitor which correspond to optical path transmission;
the silicon photonic waveguide and the silicon photonic monitor are configured to transmit and monitor an optical signal subjected to optical path transmission.

9. An optical engine for a PON OLT system, wherein the optical engine is located in an OLT component employing an SFP-DD/SFP-DD112 package, and is configured to modulate a downlink optical signal based on a single path/two paths/four paths of driving electrical signals generated by a modulation driving component of an OLT component, and the modulated downlink optical signal, after gain processing, is transmitted via an optical interface of the optical engine; and
an uplink light signal received by the optical interface of the optical engine is subjected to photoelectric conversion and then transmitted to a burst mode receiving and amplifying chipset of the OLT component located on an external region of the optical engine for processing;
the optical engine is internally provided with the silicon-based optoelectronic transceiver integrated chip according to claim 1.

10. The optical engine according to claim 9, wherein the optical interface of the optical engine is configured to receive an uplink optical signal or transmit a downlink optical signal; the optical interface comprises a single-channel Bi-directional Simplex SC interface and/or a dual-channel Bi-directional dual-Simplex LC interface; and
the optical interface is used for an optical component in an SFP-DD/SFP-DD112 package mode.

11. The optical engine according to claim 9, wherein the optical engine comprises:
a O-band laser and driving component, a O-band gain chip and driving component, an optical interface, and a gold finger array;
the O-band laser and driving component is used as a laser component to generate a laser signal serving as a downlink light source; the O-band gain chip and driving component is configured to perform gain processing on an optical signal output by the silicon-based optoelectronic transceiver integrated chip, or to perform gain processing on the uplink optical signal received by the optical interface; the gold finger array is configured to transmit electrical signals/driving electrical signals of other components in the optical engine and OLT;
when the driving electrical signal is one path of driving electrical signal, the number of the O-band laser and driving components is one, and the number of the O-band gain chip and driving components is one;
when the driving electrical signals are two paths of driving electrical signals, the number of the O-band laser and driving components is one, and the number of the O-band gain chip and driving components is two;
when the driving electrical signals are two paths of driving electrical signals, the number of the O-band laser and driving components is two, and the number of the O-band gain chip and driving components is two;
when the driving electrical signals are two paths of driving electrical signals, the number of the O-band laser and driving components is two, and the number of the O-band gain chip and driving component is one;
when the driving electrical signals are four paths of driving electrical signals the number of the O-band laser and driving components is two, and the number of the O-band gain chip and driving components is two; and
when the driving electrical signals are four paths of driving electrical signals, the number of the O-band laser and driving components is four, and the number of the O-band gain chip and driving component is one.

12. A multi-rate central office module based on a silicon-based optoelectronic integrated chip, wherein the central office module is a component employing an SFP-DD/SFP-DD112 package, and comprises an electrical interface, an analog/digital signal processing integrated component with single path/two paths/four paths of rates, an optical engine, and a burst mode receiving and amplifying chipset with multi-rate combination of single/dual/four paths;
the electrical interface is configured to achieve electrical signal transmission between the central office module and a system board;
the analog/digital signal processing integrated component is configured to perform clock data recovery, rate and/or pattern conversion processing on a downlink electrical signal with a first parameter transmitted by the system board through the electrical interface of the optical component, so as to obtain an electrical signal with a second parameter, which is used for being applied to an optical signal corresponding to the silicon-based optoelectronic integrated chip in the optical engine to achieve the modulation of the optical signal, and the modulated downlink optical signal is transmitted via an optical interface of the optical engine to a network end;
the uplink optical signal received by means of the optical interface of the optical engine is converted into an electrical signal through the receiving of the silicon-based optoelectronic integrated chip; and the electrical signal is transmitted via the burst mode receiving and amplifying chipset and the electrical interface to the system board; and
the silicon-based optoelectronic integrated chip in the optical engine is a transceiver integrated chip for achieving the integration of the transmitting and receiving of optical signals.

13. The central office module according to claim 12, wherein the silicon-based optoelectronic integrated chip in the optical engine is the silicon-based optoelectronic transceiver integrated chip for a PON OLT system.

14. The central office module according to claim 12, wherein the optical engine is the optical engine for a PON OLT system.

15. The central office module according to claim 12, wherein the electrical interface comprises a gold finger array of a printed circuit board of the SFP-DD/SFP-DD112 package;
the burst mode receiving and amplifying chipset comprises a burst mode receiving trans-impedance amplifier, and a burst mode receiving linear amplifier;
when the electrical signal with the second parameter is one path of electrical signal, there is one path of input-output burst mode electrical signals of the burst mode receiving and amplifying chipset, and the rate of the path of electrical signal of the burst mode receiving and amplifying chipset is equal to or lower than that of the electrical signal with the second parameter;
when the electrical signals with the second parameter are two paths of electrical signals, there are two paths of input-output burst mode electrical signals of the burst mode receiving and amplifying chipset, and the rates of the two paths of electrical signals of the burst mode receiving and amplifying chipset are not higher than that of the electrical signal with the second parameter; and
when the electrical signals with the second parameter are four paths of electrical signals, there are four paths of input-output burst mode electrical signals of the burst mode receiving and amplifying chipset, and the rates of the four paths of electrical signals of the burst mode receiving and amplifying chipset are not higher than that of the electrical signal with the second parameter.

16. The central office module according to claim 12, wherein
the electrical interface is configured to achieve the connection between a 25/50/100/200G PON OLT system and/or a 25/50/100/200G EPON OLT system and the central office module, and the electrical interface comprises one or more of the following interfaces: a single-path electrical interface, a dual-path electrical interface, and a four-path electrical interface.

17. The central office module according to claim 12, wherein
the analog/digital signal processing integrated component comprises:
a digital processing chip DSP and a modulation driving component for optical signal modulation of a silicon photonic chip;
the DSP is configured to perform clock data recovery, rate and/or pattern mapping conversion on a single path of electrical signal or two paths of electrical signals, i.e., the first parameter, transmitted by the electrical interface according to the parameters of optical transmission equipment, so as to obtain one path of downlink electrical signal meeting transmission parameter requirements of the optical transmission equipment, and one path of driving electrical signal, i.e., the second parameter, is obtained through the modulation driving component;
and/or
a digital processing chip DSP and a modulation driving component for optical signal modulation of a silicon photonic chip;
the DSP is configured to perform clock data recovery, rate and/or pattern mapping conversion on two paths of electrical signals transmitted by the electrical interface according to the parameters of optical transmission equipment, so as to obtain two paths of downlink electrical signals meeting transmission parameter requirements of the optical transmission equipment, and two paths of driving electrical signals, i.e., the second parameter, are obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain single path of downlink electrical signal meeting transmission parameter requirements of the optical transmission equipment, and single path of single driving electrical signal, i.e., the second parameter, is obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain two paths of downlink electrical signals meeting transmission parameter requirements of the optical transmission equipment, and two paths of driving electrical signals, i.e., the second parameter, are obtained through the modulation driving component;
and/or
a digital processing chip DSP and a modulation driving component for optical signal modulation of a silicon photonic chip;
the DSP is configured to perform clock data recovery, rate and/or pattern mapping conversion on four paths of electrical signals transmitted by the electrical interface according to the parameters of optical transmission equipment, so as to obtain four paths of downlink electrical signals meeting transmission parameter requirements of the optical transmission equipment, and the four paths of driving electrical signals, i.e., the second parameter, are obtained through the modulation driving component;
and/or
an analog/digital signal processing integrated component comprises: a dual-path retimer component and a modulation driving component for optical signal modulation;
the dual-path retimer component is configured to perform clock data recovery, rate and/or pattern mapping conversion on two paths of electrical signals transmitted by the electrical interface according to the parameters of optical transmission equipment, so as to obtain two paths of downlink electrical signals meeting transmission parameter requirements of the optical transmission equipment, and two paths of driving electrical signals are obtained through the modulation driving component;
and/or
an analog/digital signal processing integrated component comprises a four-path retimer component and a modulation driving component for optical signal modulation;
the four-path retimer component is configured to perform clock data recovery, rate and/or pattern mapping conversion on four paths of electrical signals transmitted by the electrical interface according to the parameters of optical transmission equipment, so as to obtain four paths of downlink electrical signals meeting transmission parameter requirements of the optical transmission equipment, and four paths of driving electrical signals are obtained through the modulation driving component.

18. The central office module according to claim 17, wherein
the DSP comprises: a Retimer component, a Gearbox component, and a pattern conversion module;
when a single path like 1×25 Gbps or 1×50 Gbps NRZ or 1×100 Gbps PAM4 pattern is input, the Gearbox component does not operate, and a single-path Retimer component is configured to perform clock data recovery on the single path of input electrical signal and to output single path like 1×25 Gbps NRZ or 1×50 Gbps NRZ or 1×100 Gbps PAM4 pattern as a downlink electrical signal;
when two paths like 2×25 Gbps NRZ patterns are input, the Retimer component and the Gearbox component are configured to map and convert two paths of input electrical signals 2×25 Gbps NRZ into a single path of 50 Gbps NRZ pattern, so as to serve as one path of output downlink electrical signal;
when two paths like 2×25 Gbps NRZ patterns are input, the Retimer component, the Gearbox component and the pattern conversion module are configured to map and convert two paths of input signals 2×25 Gbps NRZ into a single path of 50 Gbps PAM4 pattern, so as to serve as one path of output downlink electrical signal;
when two paths like 2×50 Gbps NRZ patterns are input, the Retimer component and the Gearbox component are configured to map and convert two paths of input electrical signals 2×50 Gbps NRZ into a single path of 100 Gbps NRZ pattern, so as to serve as one path of output downlink electrical signal;
when two paths like 2×50 Gbps NRZ patterns are input, the Retimer component, the Gearbox component and the pattern conversion module are configured to map and convert two paths of input signals 2×50 Gbps NRZ into a single path of 100 Gbps PAM4 pattern, so as to serve as one path of output downlink electrical signal; and
when two paths like 2×100 Gbps PAM4 patterns are input, the Retimer component and the Gearbox component are configured to map and convert two paths of input electrical signals 2×100 Gbps PAM4 into a single path like 1×200 Gbps PAM4 pattern, so as to serve as one path of output downlink electrical signal.

19. The central office module according to claim 17, wherein the central office module uses a retimer integrated into the DSP chip, or an independent dual-path retimer component not integrated into the DSP, and the retimer component comprises a retimer chip;
when two paths like 2×25 Gbps NRZ patterns are input, the retimer chip is configured to perform clock data recovery on two paths of electrical signals received by the electrical interface and to map and convert the electrical signals into two paths of 25 Gbps NRZ patterns, so as to serve as two paths of output downlink electrical signals;
when two paths like 2×50 Gbps NRZ patterns are input, the retimer or the DSP chip is configured to perform clock data recovery on two paths of electrical signals received by the electrical interface and to map and convert the electrical signals into two paths like 2×50 Gbps NRZ patterns, so as to serve as two paths of output downlink electrical signals;
when the two paths are input using different rate modes, one path is a 25 Gbps NRZ pattern while the other is a 50 Gbps NRZ pattern, the retimer or the DSP chip is configured to perform clock data recovery on two paths of electrical signals received by the electrical interface and to map and convert the electrical signals into one path of 25 Gbps NRZ pattern and one path of 50 Gbps NRZ pattern, so as to serve as two paths of output downlink electrical signals; and
when two paths like 2×100 Gbps PAM4 patterns are input, the retimer or the DSP chip is configured to perform clock data recovery on two paths of electrical signals received by the electrical interface and to map and convert the electrical signals into two paths like 2×100 Gbps PAM4 patterns, so as to serve as two paths of output downlink electrical signals.

20. The central office module according to claim 17, wherein the four-path retimer or the DSP component comprises: a retimer or DSP chip;
when four paths like 4×25 Gbps NRZ patterns are input, the retimer or DSP chip is configured to perform clock data recovery on four paths of electrical signals received by the electrical interface and to map and convert the four electrical signals into four paths of 25 Gbps NRZ patterns, so as to serve as four paths of downlink electrical signals for output;
when four paths like 4×25 Gbps NRZ patterns are input, the DSP chip is configured to perform clock data recovery on four paths of electrical signals received by the electrical interface and to map and convert the electrical signals by the Gearbox into a single path of 100 Gbps PAM4 pattern, so as to serve as a single path of output downlink electrical signal;
when four paths like 4×25 Gbps NRZ patterns are input, the DSP chip is configured to perform clock data recovery on four paths of electrical signals received by the electrical interface and to map and convert the electrical signals by the Gearbox into two paths like 2×50 Gbps PAM4 or NRZ patterns, so as to serve as two paths of output downlink electrical signals;
when four paths like 4×50 Gbps NRZ patterns are input, the retimer or DSP chip is configured to perform clock data recovery on four paths of electrical signals received by the electrical interface and to map and convert the electrical signals into four paths like 4×50 Gbps NRZ patterns, so as to serve as four paths of output downlink electrical signals;
when four paths like 4×50 Gbps NRZ patterns are input, the DSP chip is configured to perform clock data recovery on four paths of electrical signals received by the electrical interface and to map and convert the electrical signals by the Gearbox into a single path of 200 Gbps PAM4 pattern, so as to serve as a single path of output downlink electrical signal;
when four paths like 4×50 Gbps NRZ patterns are input, the DSP chip is configured to perform clock data recovery on four paths of electrical signals received by the electrical interface and to map and convert the electrical signals by the Gearbox into two paths like 2×100 Gbps PAM4 patterns, so as to serve as two paths of output downlink electrical signals; and
when four paths like 2×25 Gbps and 2×50 Gbps are input in combination, the retimer or DSP chip is configured to perform clock data recovery on four paths of electrical signals received by the electrical interface and to map and convert the electrical signals into four paths like 2×25 Gbps and 2×50 Gbps NRZ patterns, so as to serve as four paths of output downlink electrical signals.

21. The central office module according to claim 17, wherein the modulation driving component is a silicon photonic modulation driving component, and integrated into the DSP, or is integrated on a component with the retimer chip.

22. A passive optical network PON OLT system, comprising the multi-rate central office module based on the silicon-based optoelectronic integrated chip according to claim 12, wherein the PON OLT system interacts with a PON network side through the central office module.
